(19) United States
(12) Patent Application Publication
(10) Pub. No.: US 2020/0219110 A1
(43) Pub. Date: Jul. 9, 2020

(54) Sales Discovery Tool

(71) Applicant: American Family Life Assurance Company of Columbus, Columbus, GA (US)

(72) Inventors: Jesse Blake Wallace, Atlanta, GA (US); Ashley Lauren Hardage, Atlanta, GA (US); Amanda Harkins Hunt, Atlanta, GA (US); William Charles Hankinson, Atlanta, GA (US); Maria del Rosario Huffman, Atlanta, GA (US)

(21) Appl. No.: 16/736,779

(22) Filed: Jan. 7, 2020

Related U.S. Application Data
(60) Provisional application No. 62/789,427, filed on Jan. 7, 2019.

(51) Int. Cl. G06Q 30/00; G06Q 30/06; G06Q 10/06

(52) U.S. Cl. CPC G06Q 30/01; G06Q 10/06393; G06Q 30/0631

(57) ABSTRACT

Systems and methods are provided for generating a list of questions for a sales conversation. A first set of questions is provided for the sales representatative. The response to one or more of the first questions may determine the next set of questions. Once a sufficient amount of information is received in response to the questions, the system may provide a list of products to offer to the customer. Additional parameters may be provided which are based on the answers to the questions.

### CROSS REFERENCE TO RELATED APPLICATIONS

This application is a continuation of and claims the benefit of the filing date of U.S. provisional patent application Ser. No. 62/789,427 entitled “Sales Discovery Tool”, which was filed on Jan. 7, 2019 (the “application”) and which shares the same inventors as this application. The application is hereby incorporated by reference as if fully set forth herein.

### FIELD OF THE TECHNOLOGY

The technology of the application relates generally to question generation for steering conversations and more specifically but not exclusively to a question generation system for guiding a conversation to locate areas within a business where the business may need products or services to diminish or alleviate pain points.

### BACKGROUND OF THE TECHNOLOGY

Often times on a sales call to a business, the sales representative may have a list of products and/or services to sell but is not familiar enough with the company to determine exactly which products and/or services to offer.

It may be advantageous to create a system that prompts the sales representative with questions for the company representative, which guides the conversation to locate products and/or services that the sales representative has available which may be useful to the company.

### BRIEF SUMMARY OF THE TECHNOLOGY

Many advantages will be determined and are attained by one or more embodiments of the technology, which in a broad sense provides systems and methods for assisting sales representatives to converse with a potential customer to identify needs and match products and/or services with the needs. The sales representative may be provided with a list of questions then based on the received response, another set of questions may be provided. The sales representative may decide to use the prompted questions, skip one or more of the prompted questions, skip all the prompted questions and/or request a new set of questions. The sales representative's decision determines if follow-up question(s) will be presented. The technology may employ fuzzy logic, a logic tree, standard questions and/or a combination of any or all of these to provide real time pain point results. The system may channel the information inputs into visual representations of pain levels for different pain points. The sales representative and/or the to system may control which pain points to lock in as final. This allows for “free style” dialogue usually pursued and preferred by more advanced and experienced sales representatives but also allows for structured dialogue which may be preferred by novice sales representatives. The platform works with few or multiple inputs. The result may be a summary of top two pain points and suggested products and/or services that could provide a proper solution to the top pain points. The number of pain points is a design choice and the top pain points may include fewer or more than two.

In one or more embodiments, a computer-implemented method is provided for generating a list of questions conducive for a sales conversation between a sales representative and a customer. The sales conversation may relate to a technology of the customer. At least a portion of the method may be performed by a computing device which includes a processor, an input and a display. The method may include the computing device displaying a first set of questions on the display and receiving a response to at least one question. The computing device determining a follow-up set of questions to the at least one question and displaying the follow-up set of questions on the display. The method may also include the computing device determining at least one pain point for the customer based at least in part on the received response.

In one or more embodiments, a non-transitory computer-readable medium is provided which includes one or more computer-executable instructions that, when executed by at least one processor of a computing device, cause the computing device to display a first set of questions on a display. The computing device may receive a response to at least one of the questions and determine a follow-up set of questions to the at least one question. The computing device may also display the follow-up set of questions on the display. The computing device may also determine at least one product recommendation based at least in part on the received response and display the at least one product recommendation on the display.

In one or more embodiments, a system may be provided for generating a list of questions conducive for a sales conversation between a sales representative and a customer. The sales conversation may be related to a technology of the customer. The system may include a storage device storing questions for the sales representative to ask the customer and a set of product identifications. The system may include an input which receives a response to at least one of the questions and a logic configured to determine another of the questions for the sales representative to ask the customer based at least in part on the received response. The logic may also determine at least one product identification to recommend based at least in part on the received response.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with the accompanying drawings which illustrate a sample conversation which is guided by the technology.

FIGS. 1A-J provide an exemplary conversation in accordance with one or more embodiments of the technology;

FIGS. 2A-D provide an exemplary review of the conversation of FIGS. 1A-J in accordance with one or more embodiments of the technology;

FIGS. 3A-T provide exemplary questions in accordance with one or more embodiments of the technology;

FIGS. 4A-E provide an exemplary defined contribution planner in accordance with one or more embodiments of the technology;

FIGS. 5A-H provide recommendations of products in accordance with one or more embodiments of the technology; and,

FIG. 6A-B provides an exemplary page illustrating an option to receive a summary of the selected products in accordance with one or more embodiments of the technology;

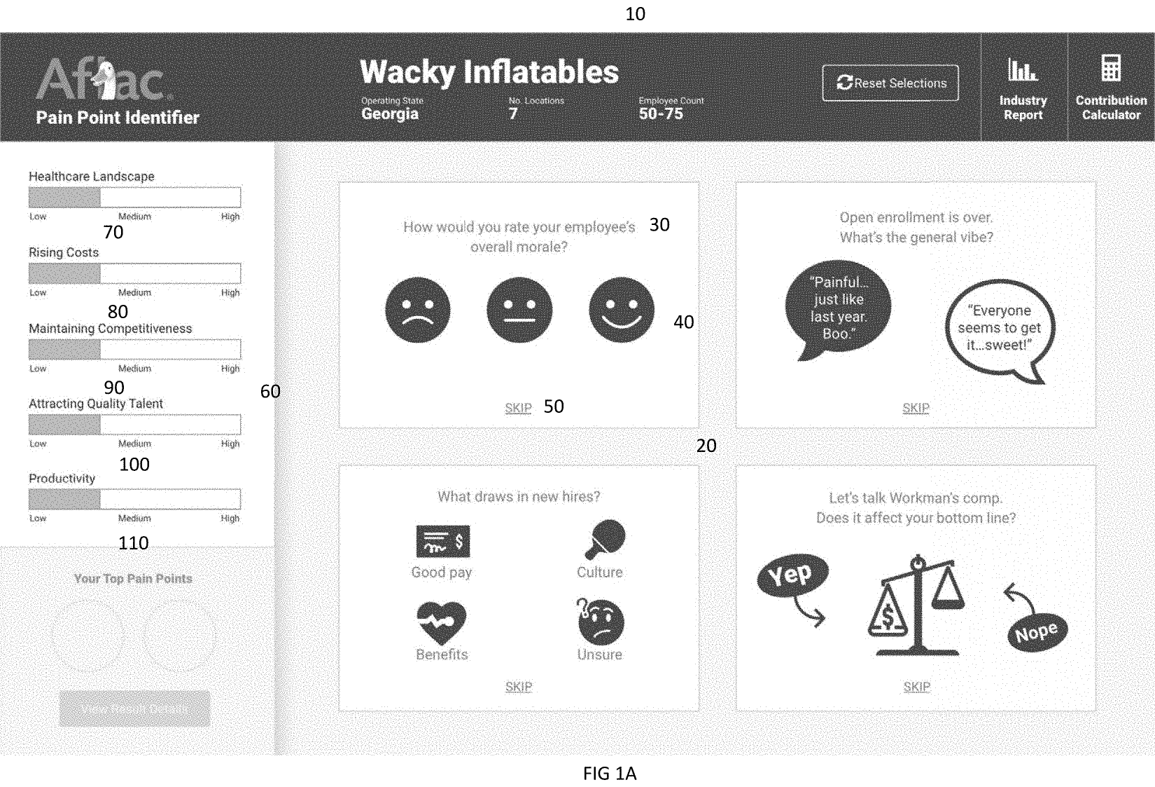

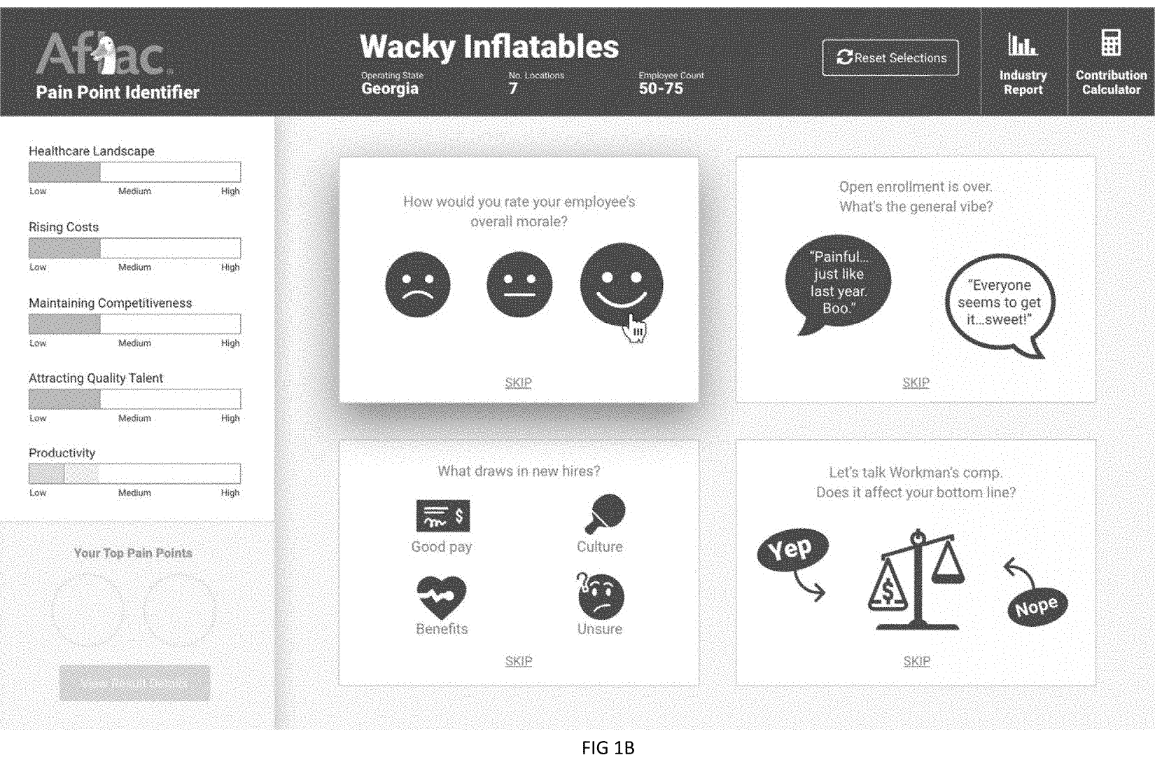

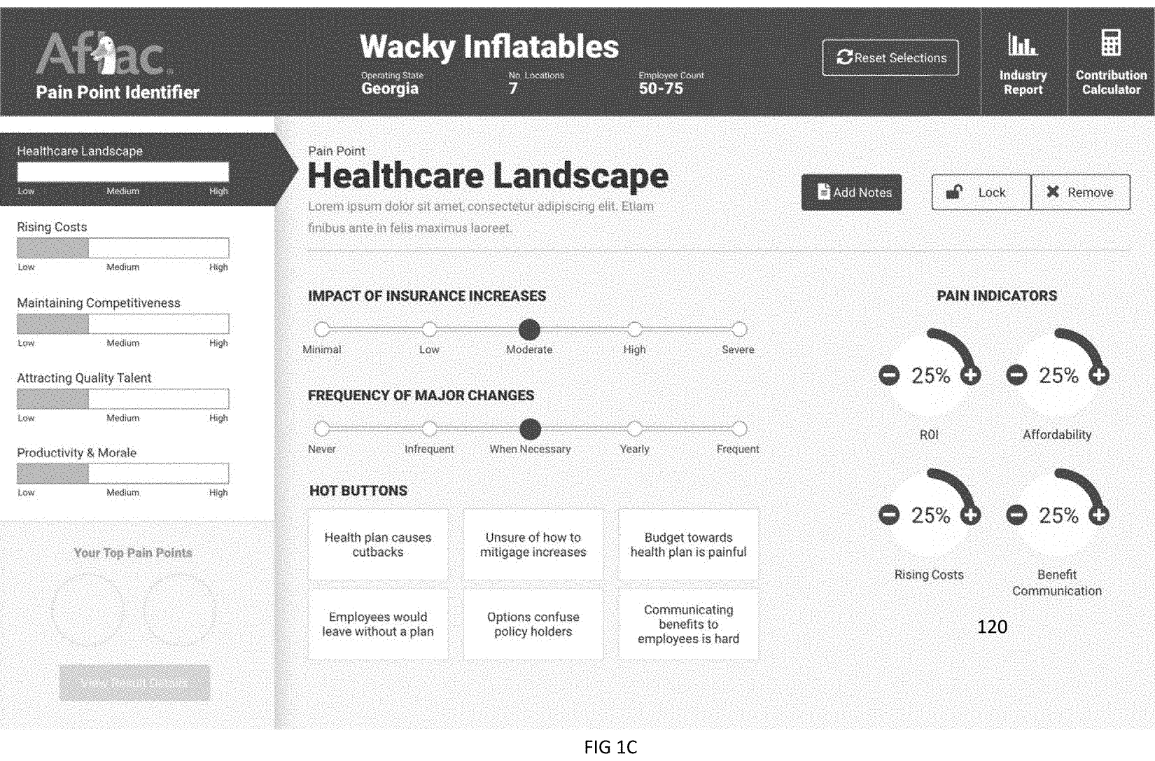

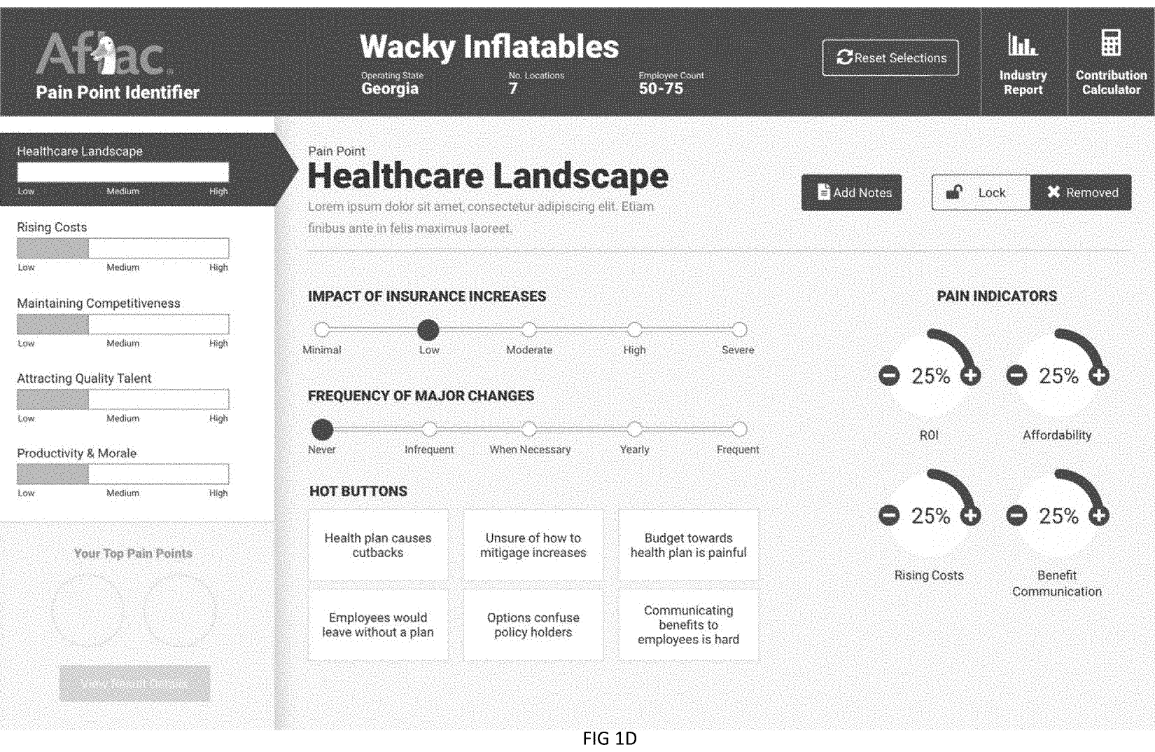

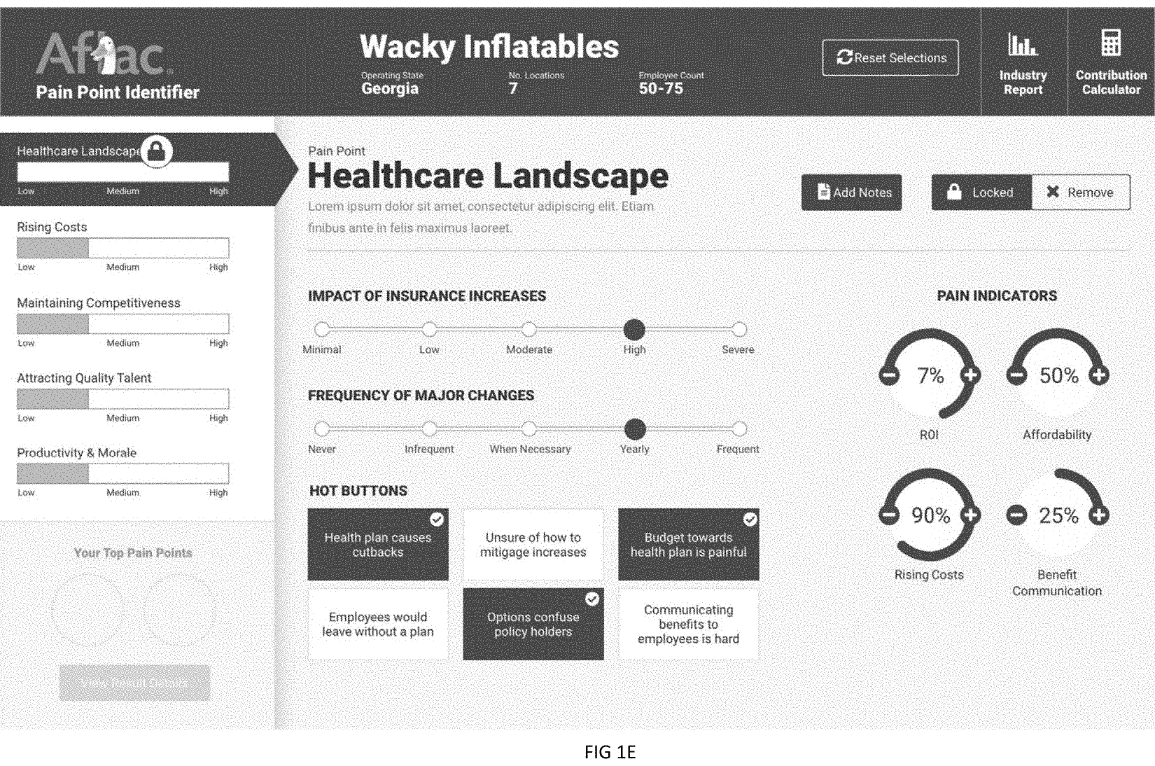

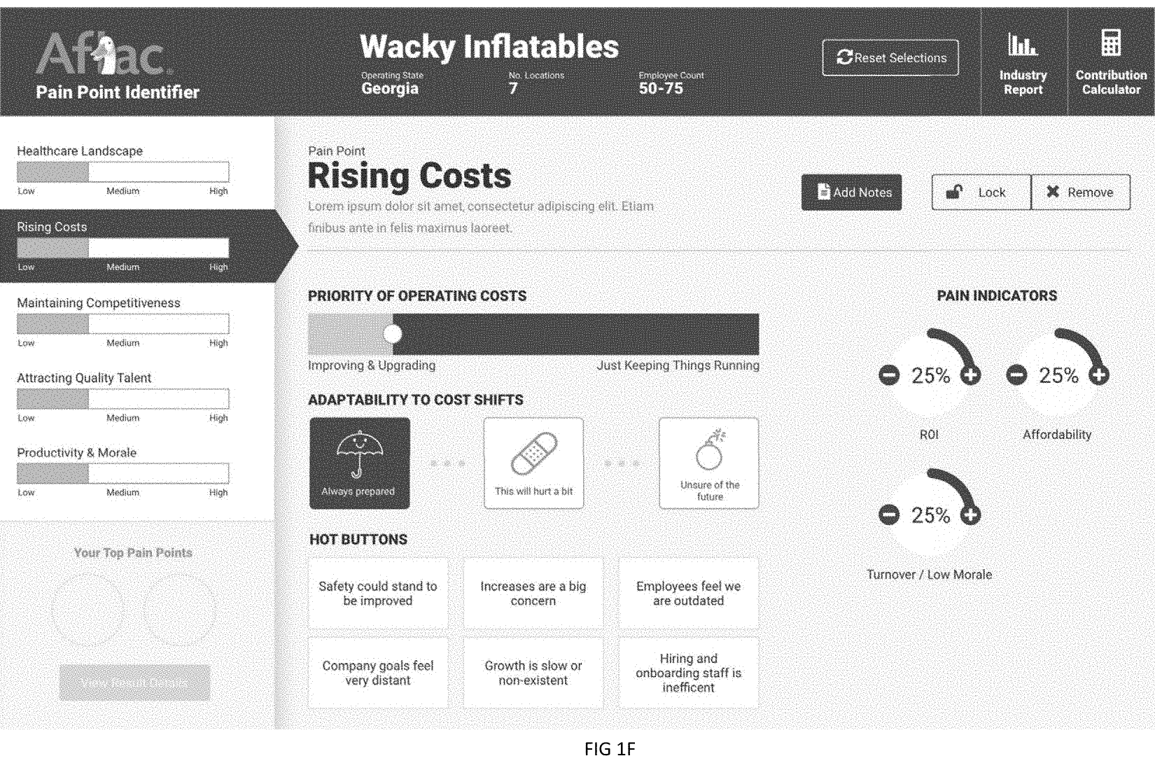

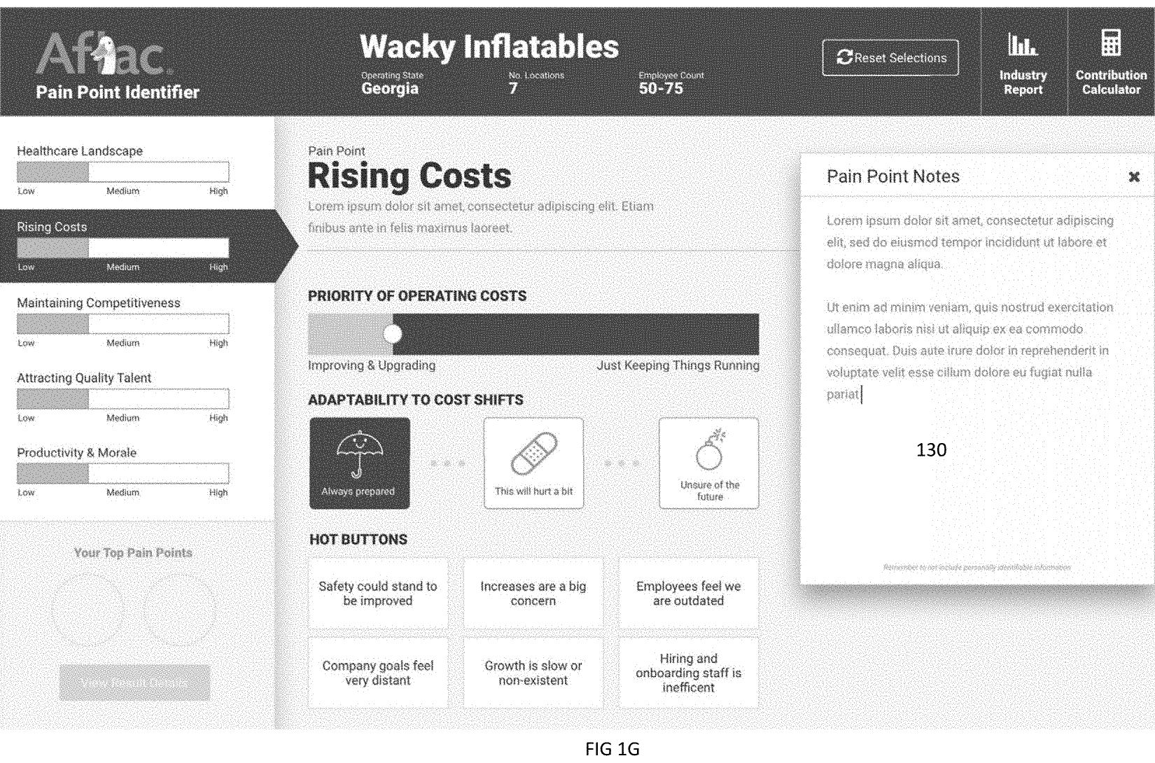

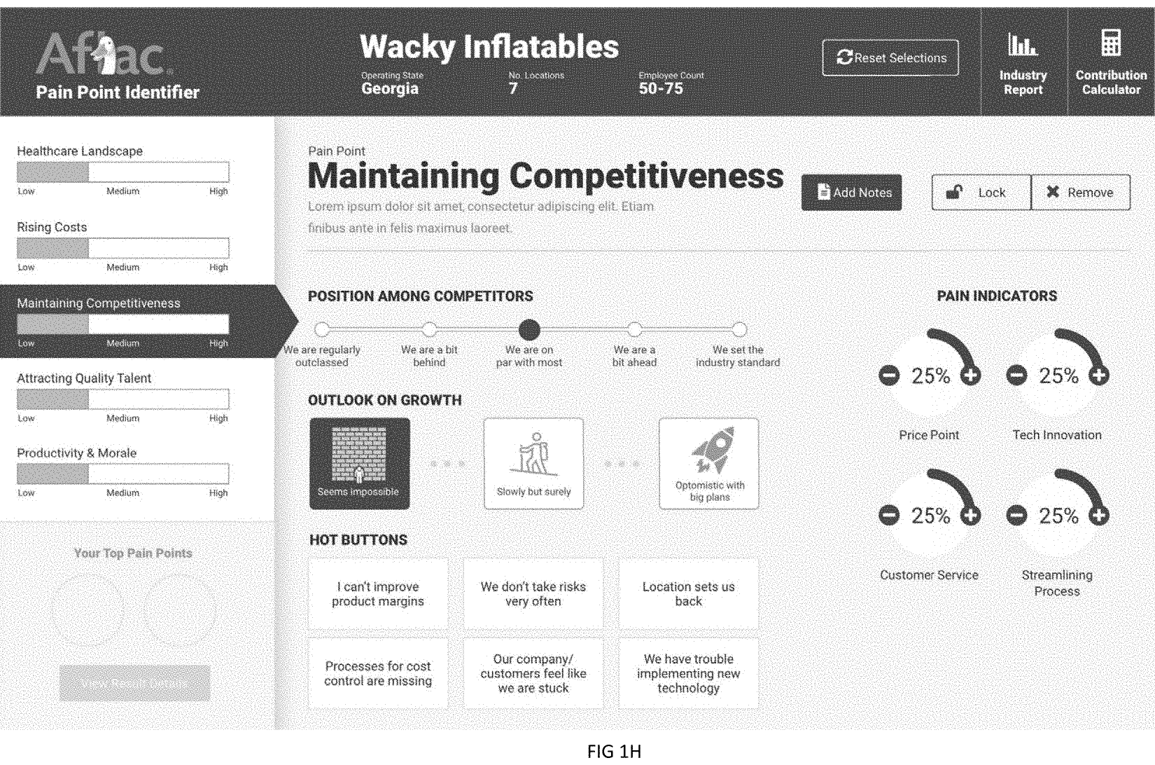

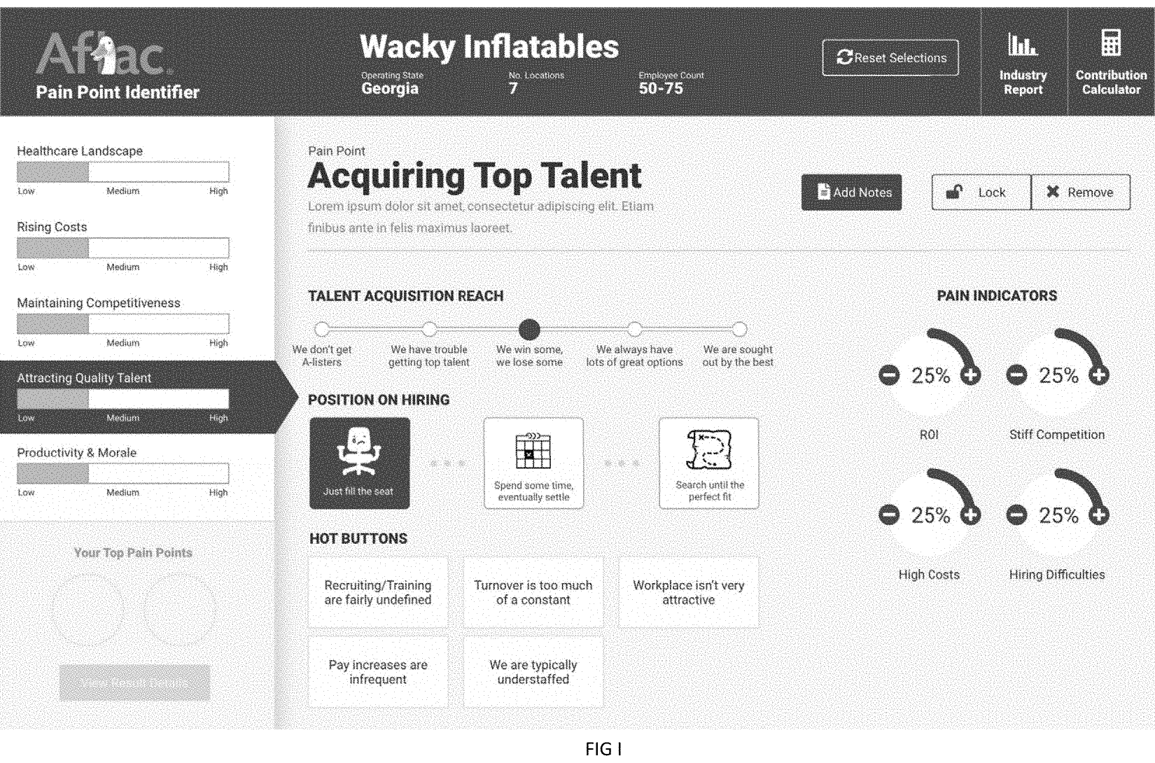

### DETAILED DESCRIPTION OF THE TECHNOLOGY

One or more embodiments of the technology provides, in a broad sense, systems and methods for assisting sales personnel to determine products and/or services that best fit the needs of potential clients (e.g. companies).

The following description will focus on technology related to the insurance industry, but those skilled in the art will recognize that other industries or consumer groups may be assisted by the technology without departing from a scope of the technology.

Discussion of an embodiment, one or more embodiments, an aspect, one or more aspects, a feature, one or more features, or a configuration or one or more configurations is intended to be inclusive of both the singular and the plural depending upon which provides the broadest scope without running afoul of the existing art and any such statement is in no way intended to be limiting in nature. Technology described in relation to one or more of these terms is not necessarily limited to use in that embodiment, aspect, feature or configuration and may be employed with other embodiments, aspects, features and/or configurations where appropriate.

For purposes of this disclosure “product” or “service” means one or more products, services, combination of product and service, product bundles/portfolios, service bundles/portfolios and/or combination of product and service bundles/portfolios.

For purposes of this disclosure “computer” or “device” means a computer terminal, mobile phone, laptop computer, tablet computer, personal digital assistant (“PDA”), electronic reader (“e-reader”), mobile game console, smart watch, smart glasses, voice assistant devices, or any other mobile device which has the ability to run apps, display and run a webpage, and transmit and receive data.

For purposes of this disclosure “remote” means accessible via a network, telephone, email, text, video, website a combination of the same or any other form of communication wherein the parties need not be collocated to communicate.

For purposes of this disclosure “customer” means an actual customer and/or a potential customer and may be used interchangeably with “client”, “company”, “business”, or “individual”.

As with most software, the sales representative may login by entering name, password and any other conventional information that is usually entered for signing into a computer program. Those skilled in the art will recognize that the information collected for this purpose is a design choice. Requiring a login is also design choice. The sales representative may be requested to enter a technology center id so that questions and or products specific to that technology may be presented to that sales representative. It is also envisioned that the program may offer the sales representative with a choice of technologies (e.g. insurance, accounting, Internet Technology (IT), administrative, human expertise, etc.) after the sales representative enters the program or the program may be specific to a single technology. The aforesaid list of technologies is not exhaustive, and the technology may be applicable to other businesses.

One or more embodiments of the technology may provide the sales representative with a request for information 10 about the potential customer/company. Based at least in part on the entered information, the program may provide one or more questions 20 for the sales representative to ask. One or more of the questions may have a weight associated therewith to indicate to the sales representative the importance of the question. The weight may be a general weight and/or it may provide a ranking of the questions presented. For purposes of this disclosure, the term “question” may include a standard question, a topic for discussion and/or identification of a business circumstance. The sales representative may decide which of the questions to ask and in which order and/or one or more questions may be required or required to be asked in a specific order. The questions may be multiple choice, true/false, they may provide a scale for the answer, they may provide a space for a one or two-word response and/or they may include topic and/or business circumstance buttons. The possible answers may be portrayed in both text 30 and/or imagery 40 (e.g. a smiley face, neutral face, and sad face, a sliding scale with numbers, the words true and false, etc.). As illustrated in the attached figures, the sales representative may be provided with the ability to skip 50 one or more of the questions 20, although in one or more embodiments, the sales representative may be required to ask certain of the questions 20 on the screen prior to being allowed to progress. As also illustrated, the sales representative may be provided with a running meter/gauge 60 of various parameters such as the ability to attract new talent 70, the ability to keep talent, costs 80, productivity 110, etc. derived at least in part from one or more of the answers to the questions being asked.

In one or more embodiments, the system may be partially or fully automated such that the sales representative may ask one or more questions, and/or the system may present one or more questions to the customer (visually in the event that the customer is connected to the system directly such as at a kiosk or remotely via a network connection and/or verbally if there is an audio connection to the customer).

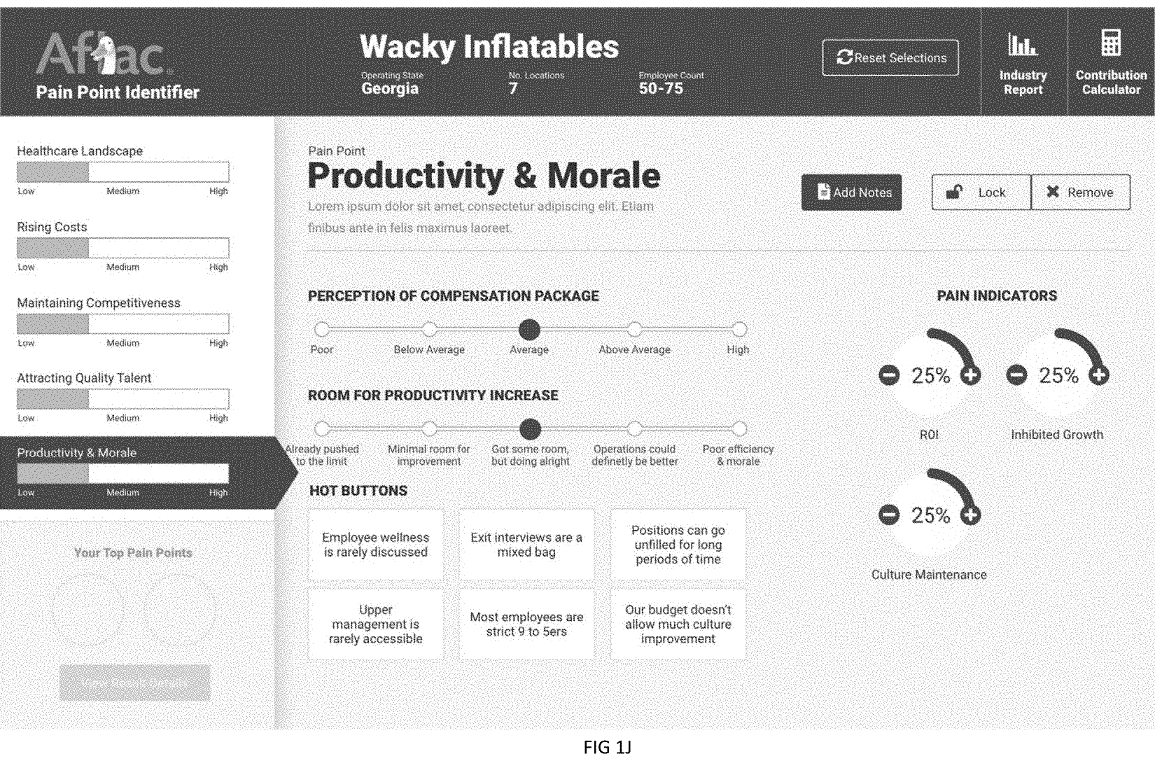

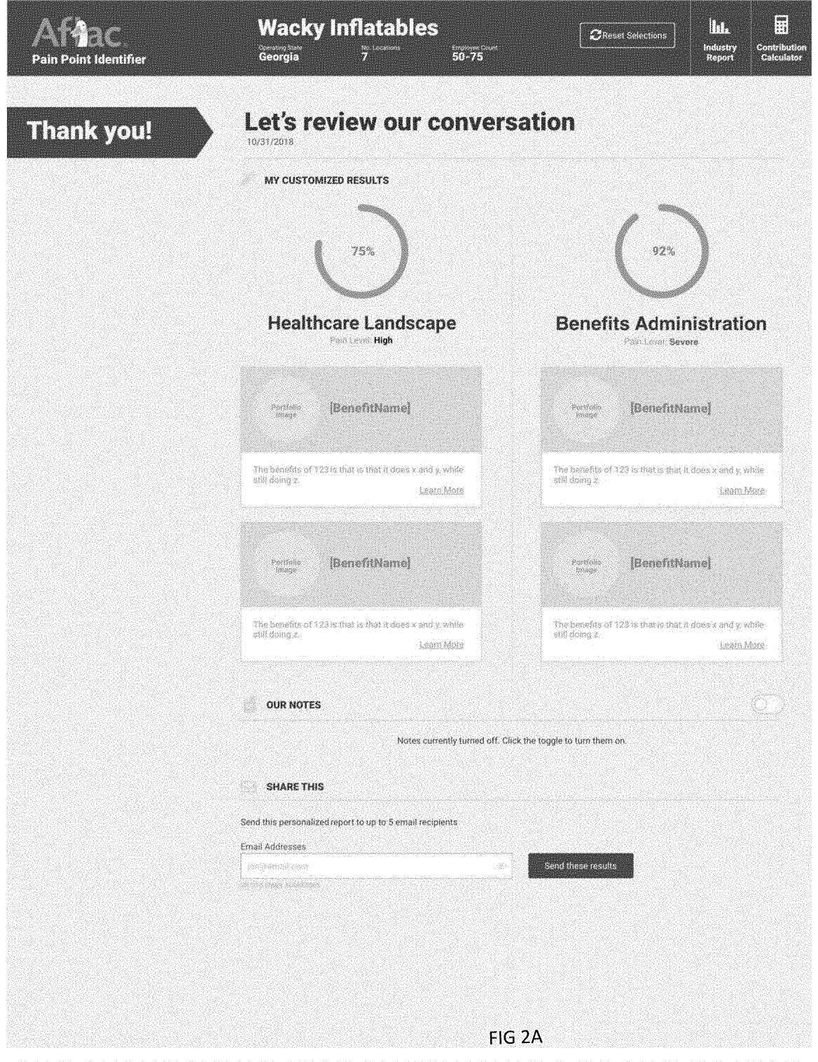

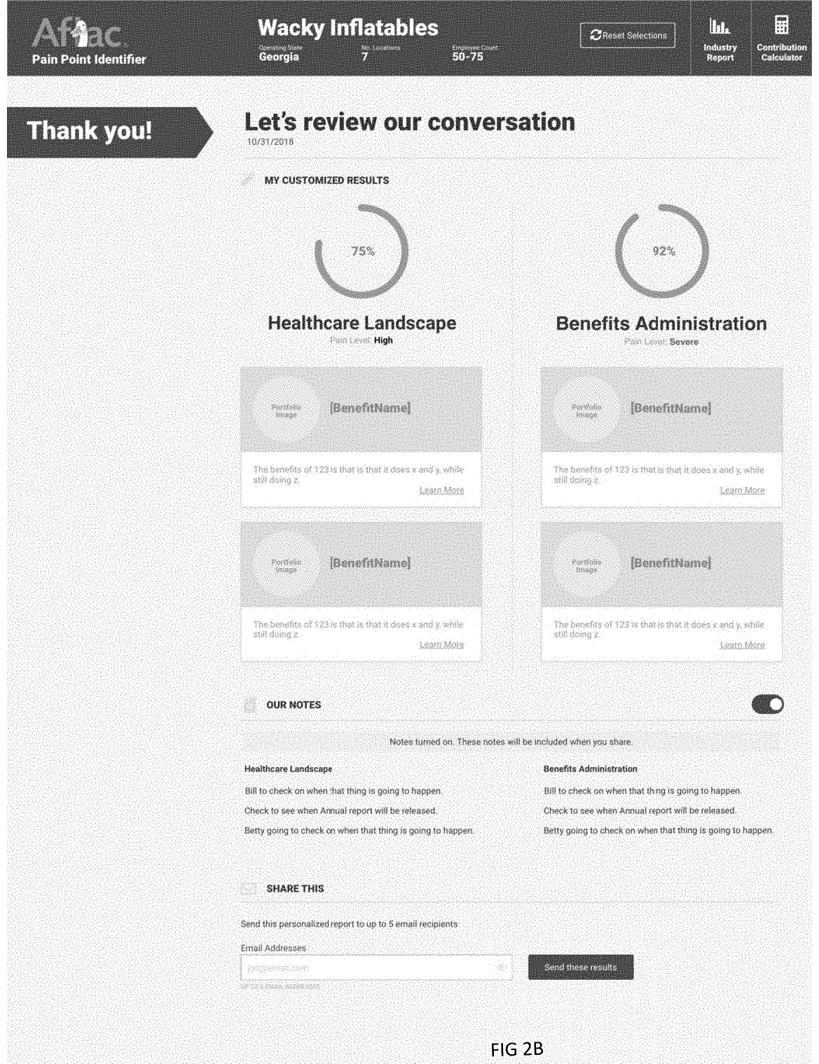

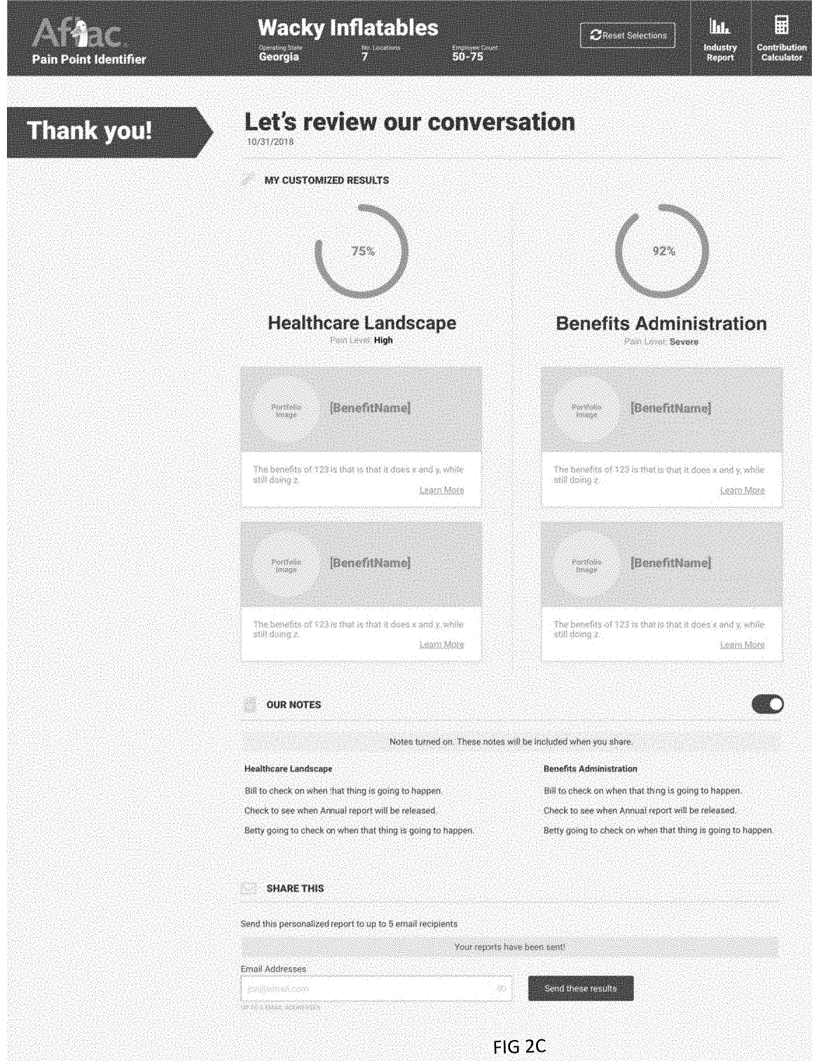

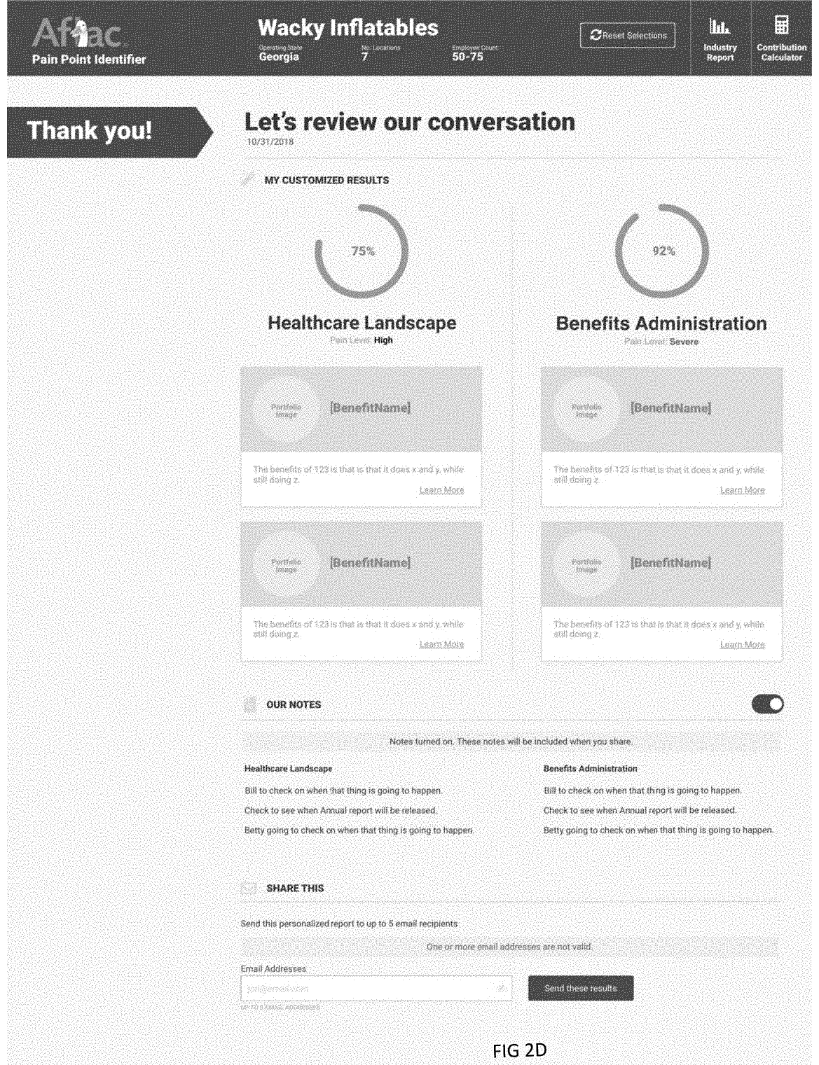

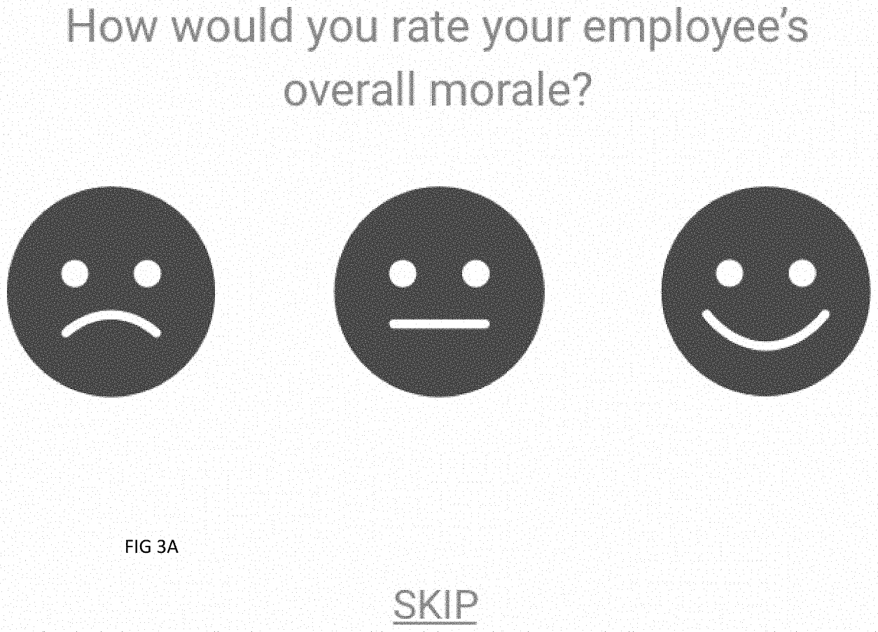

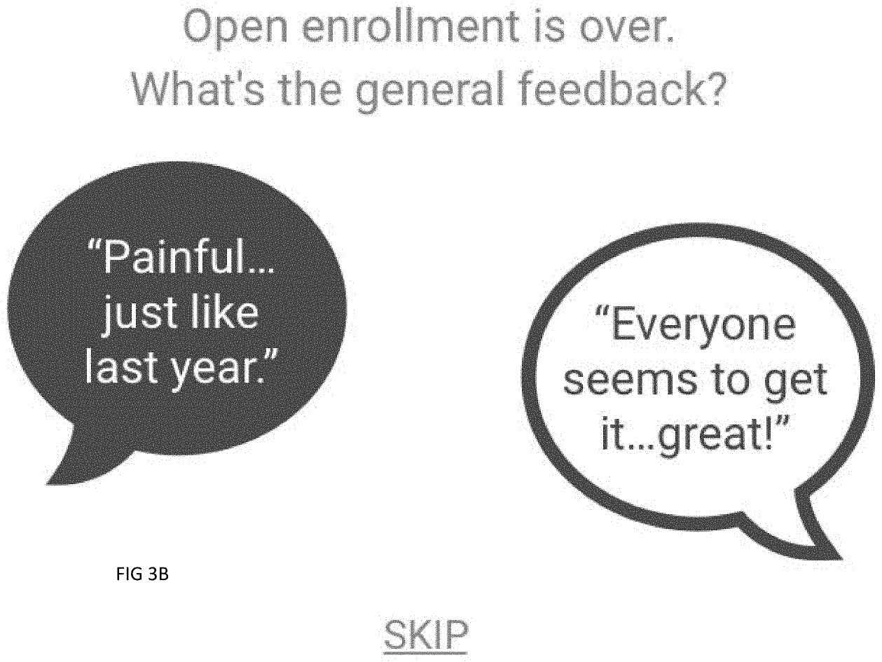

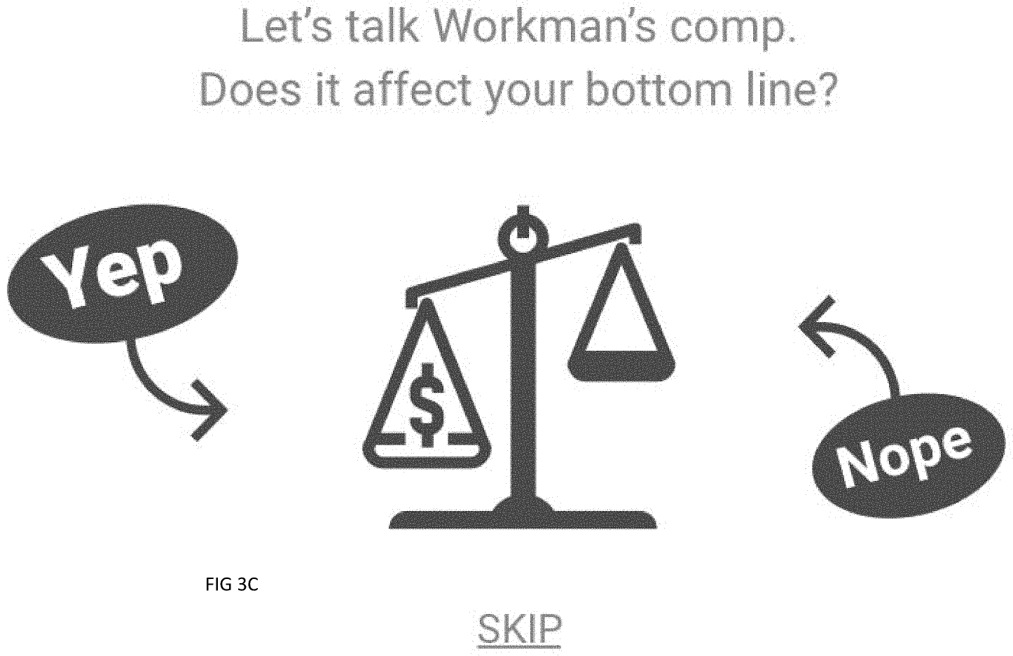

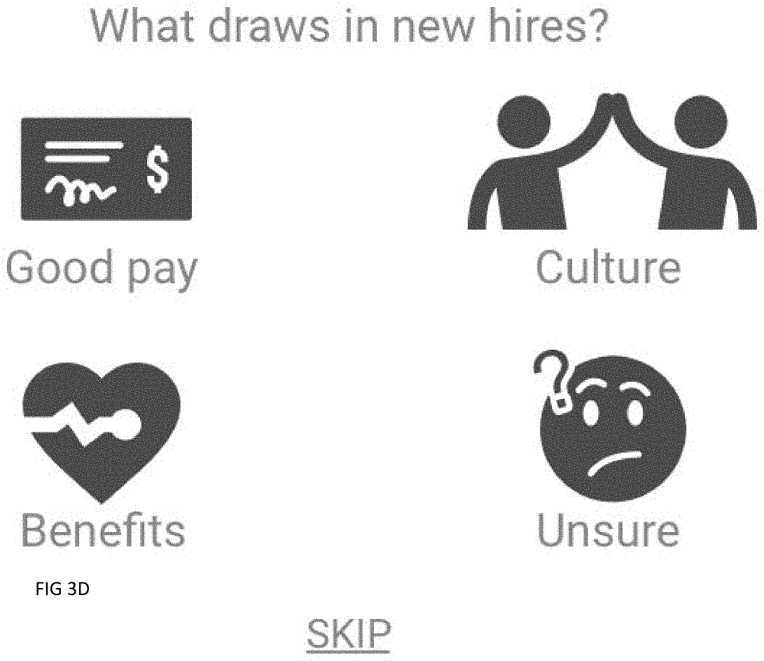

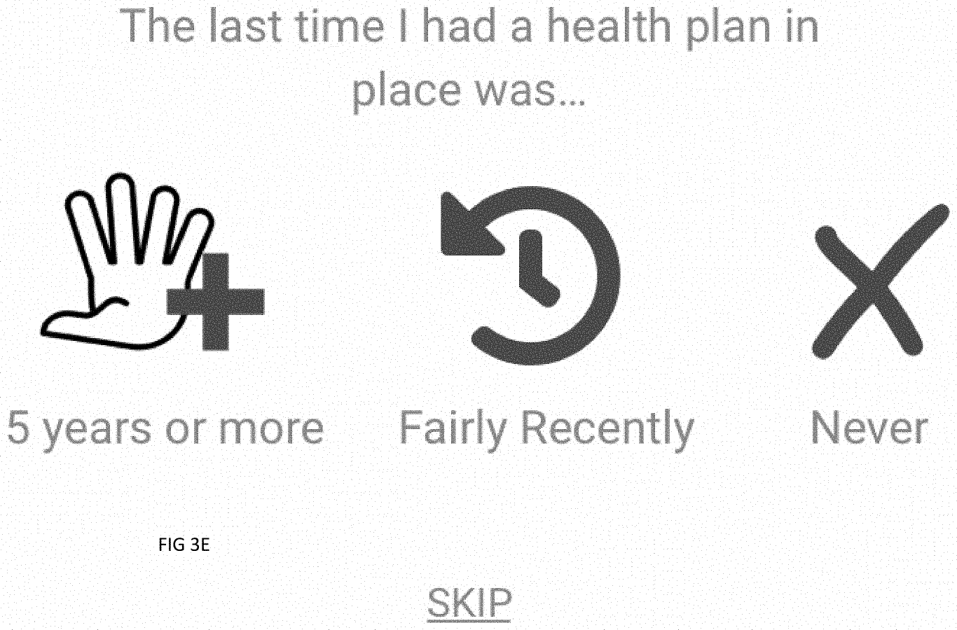

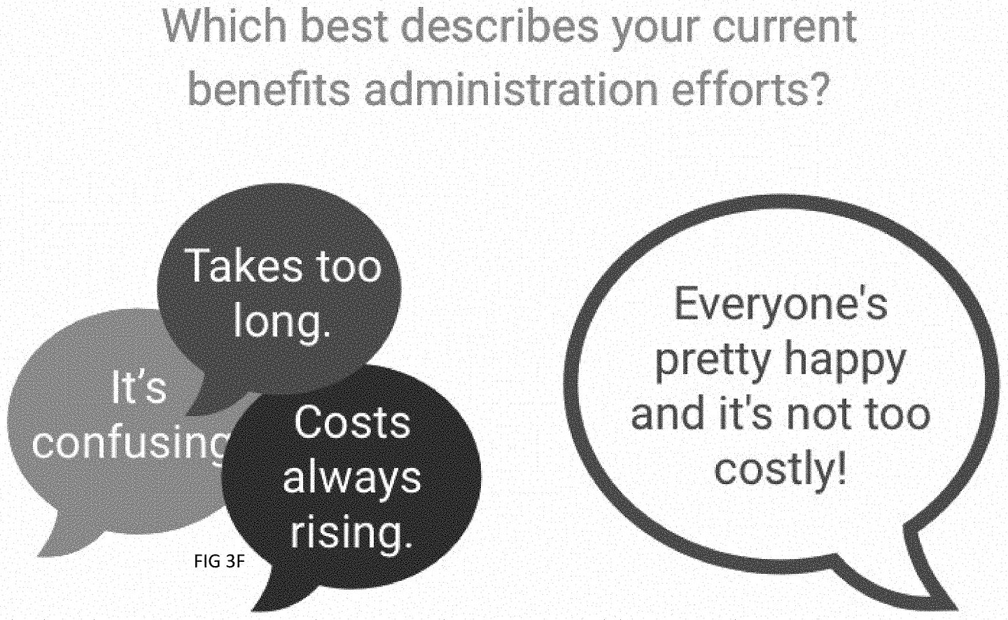

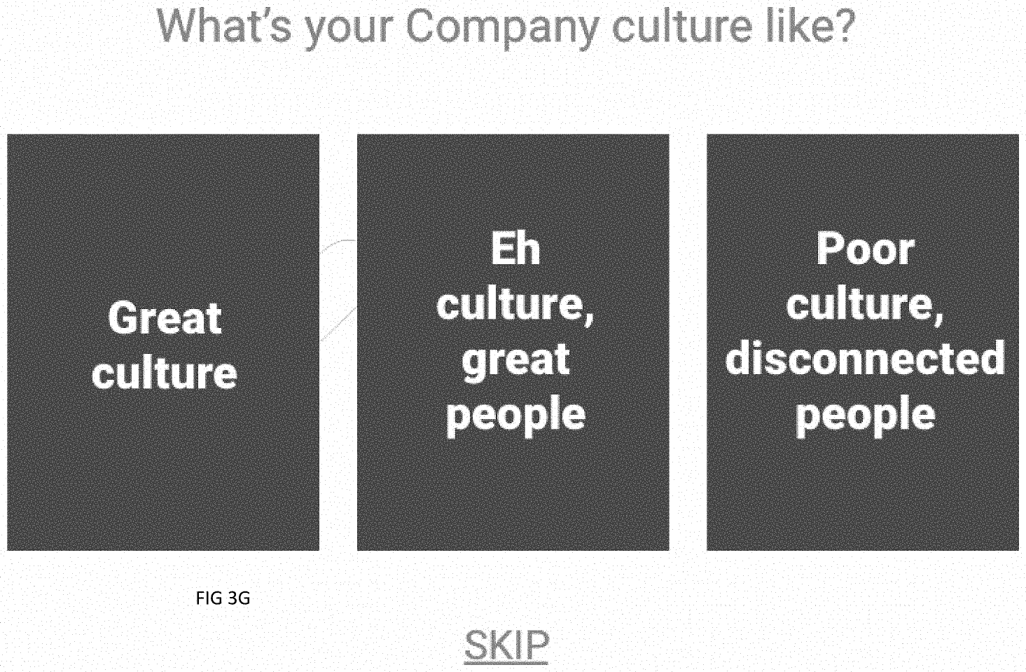

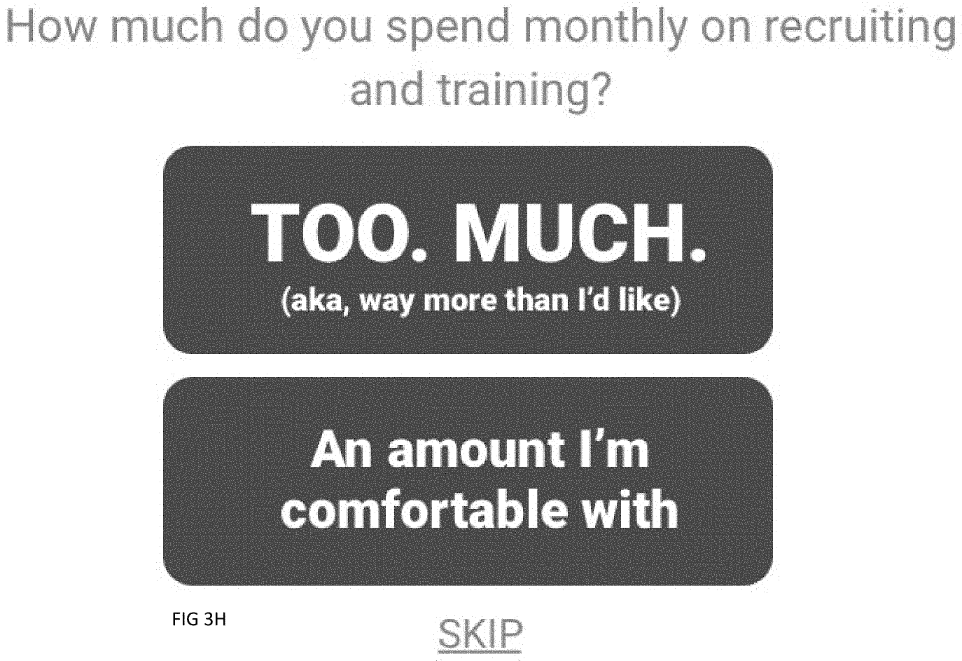

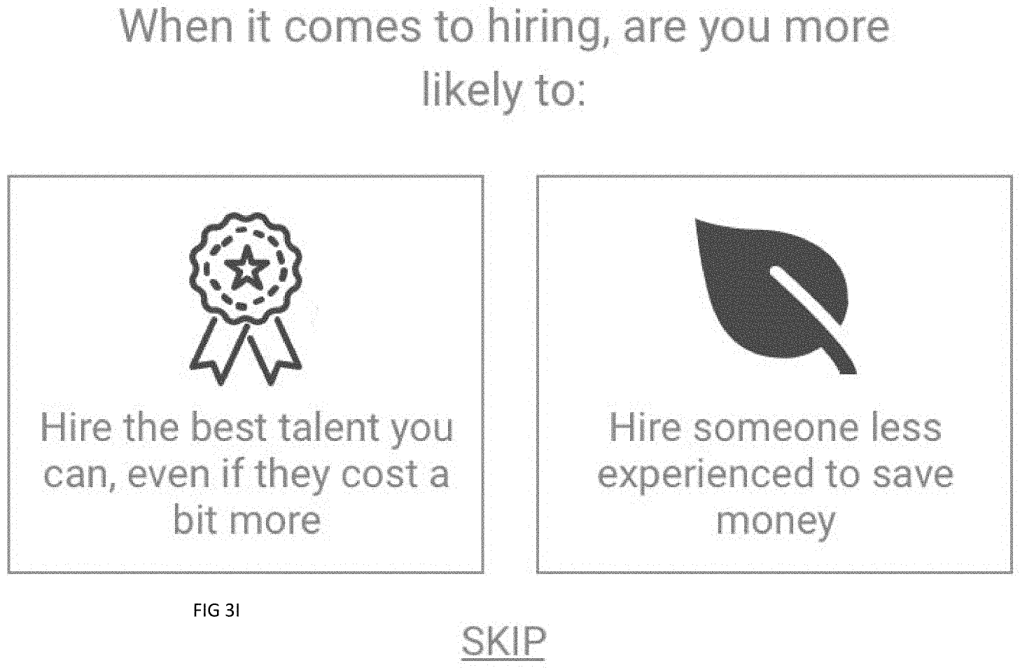

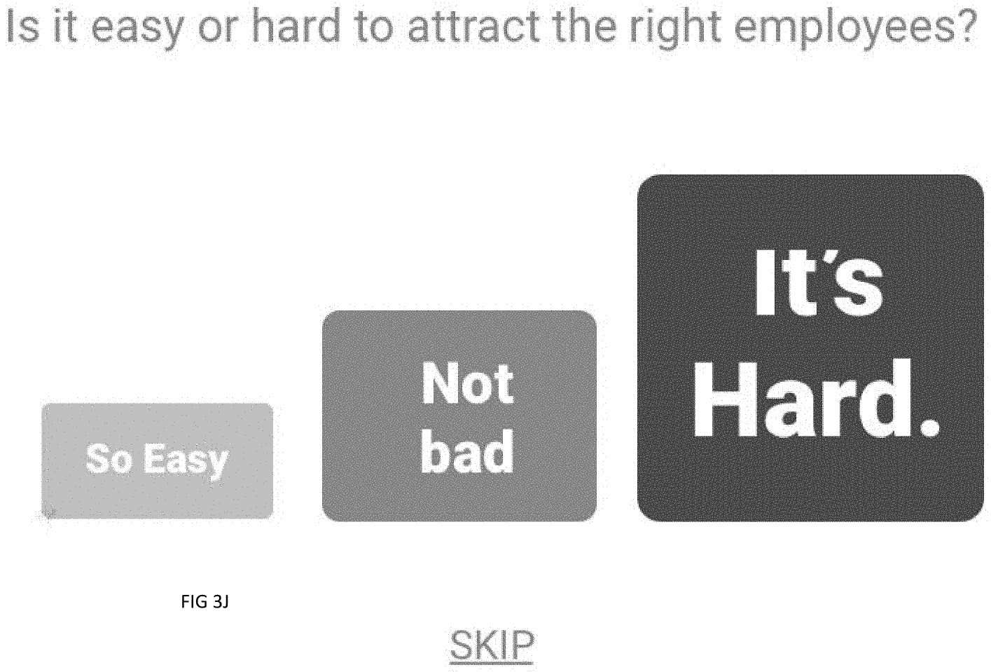

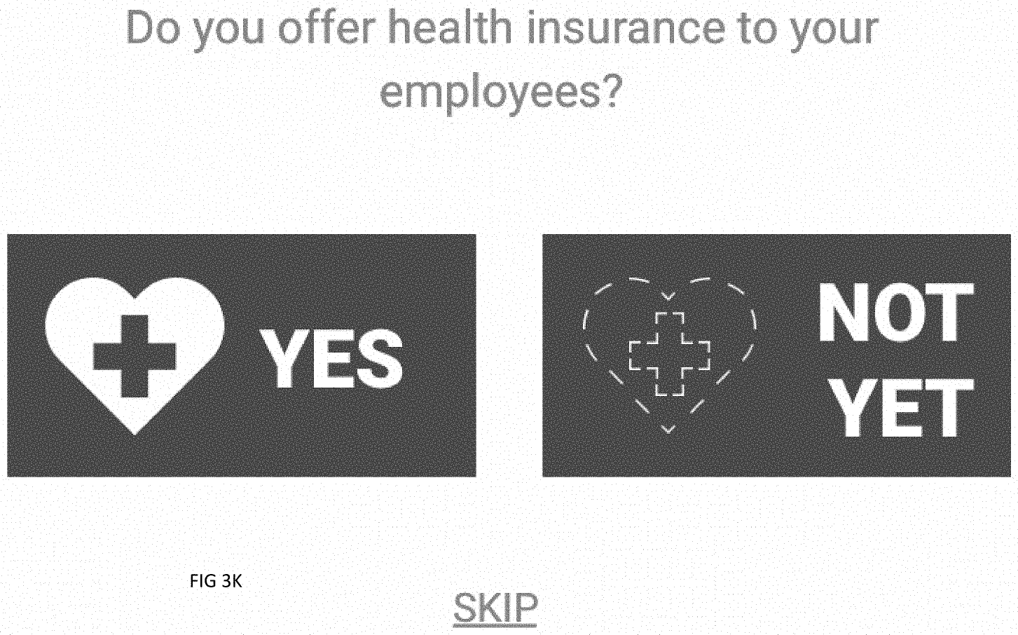

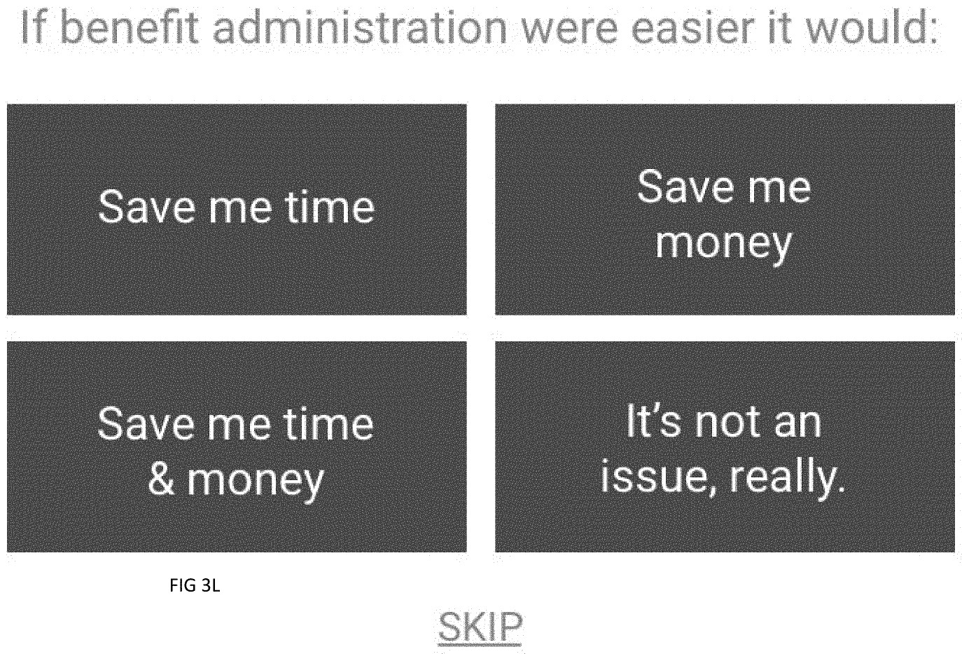

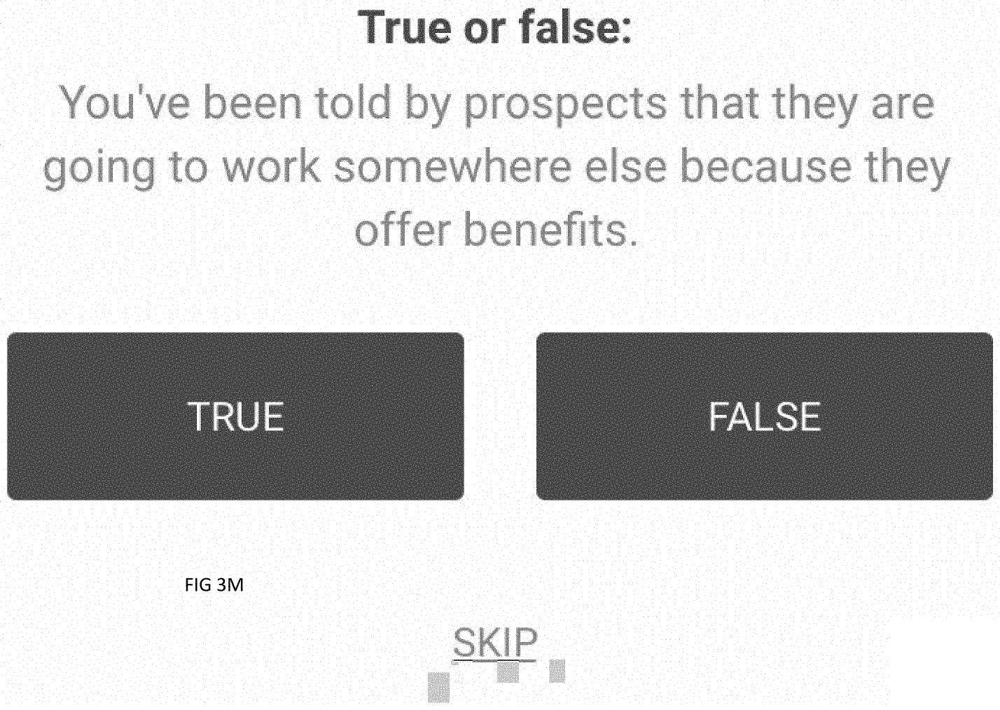

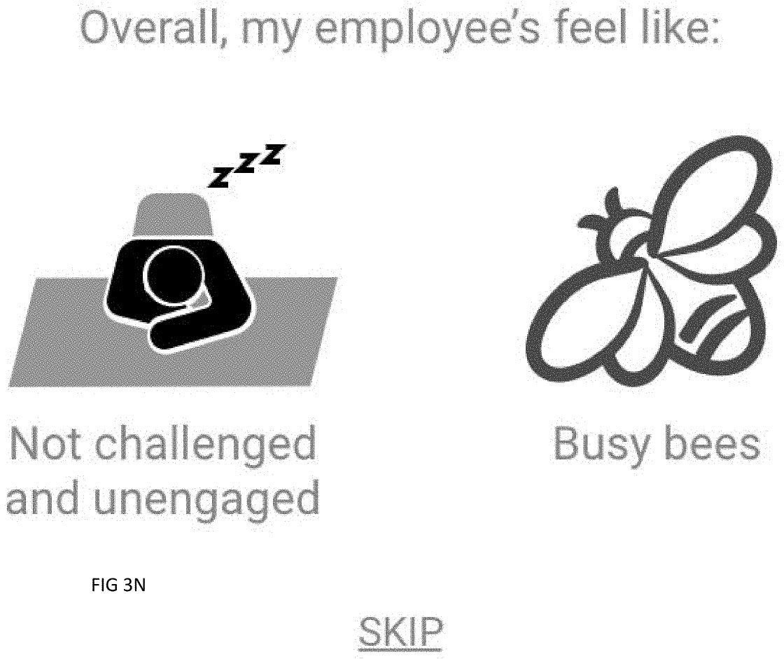

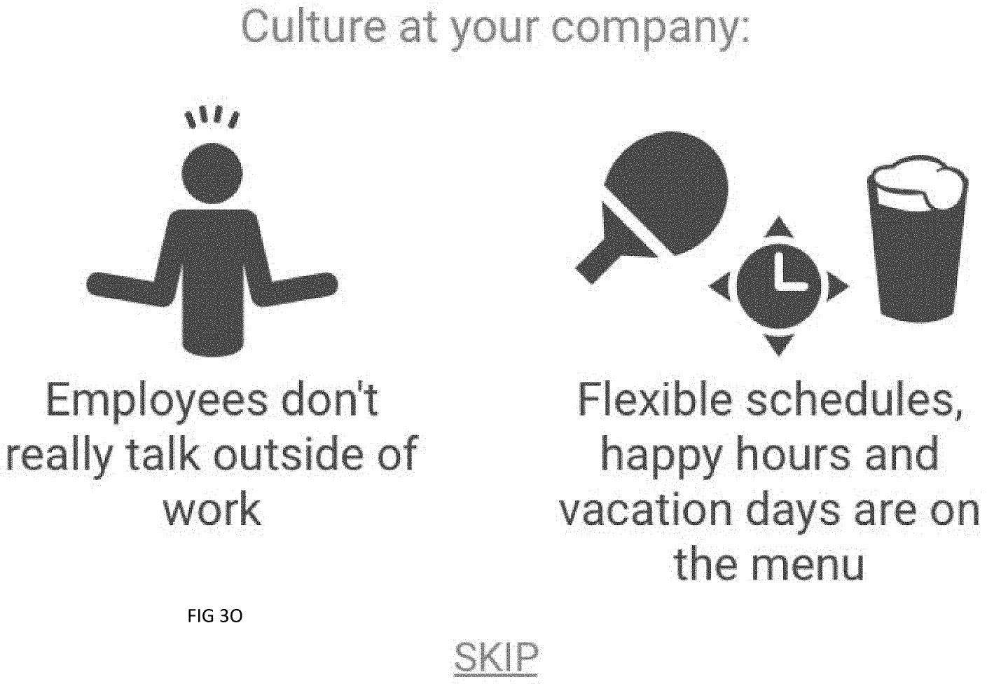

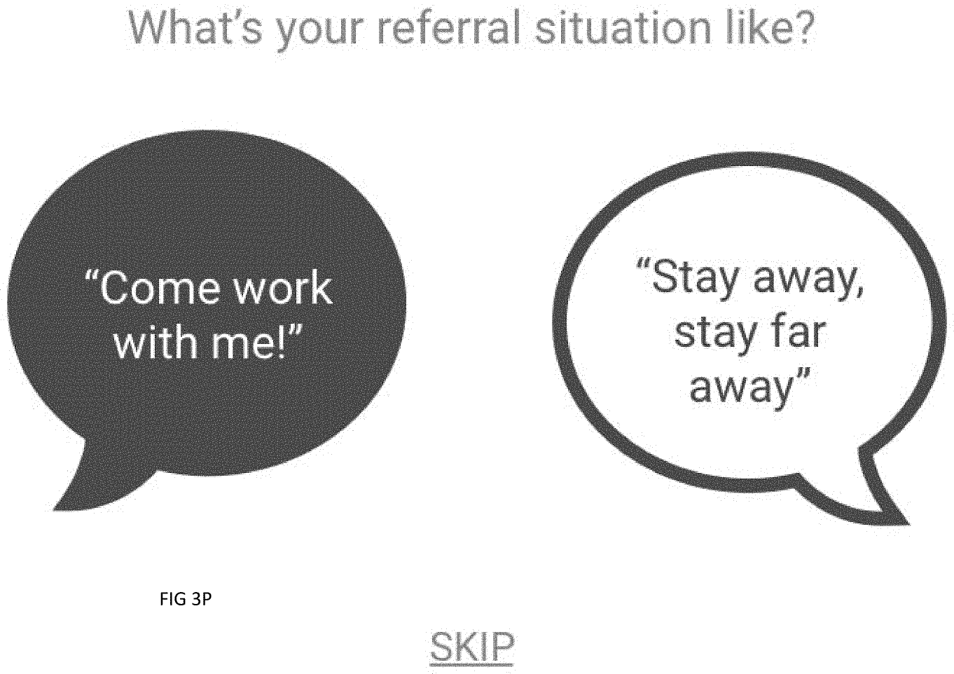

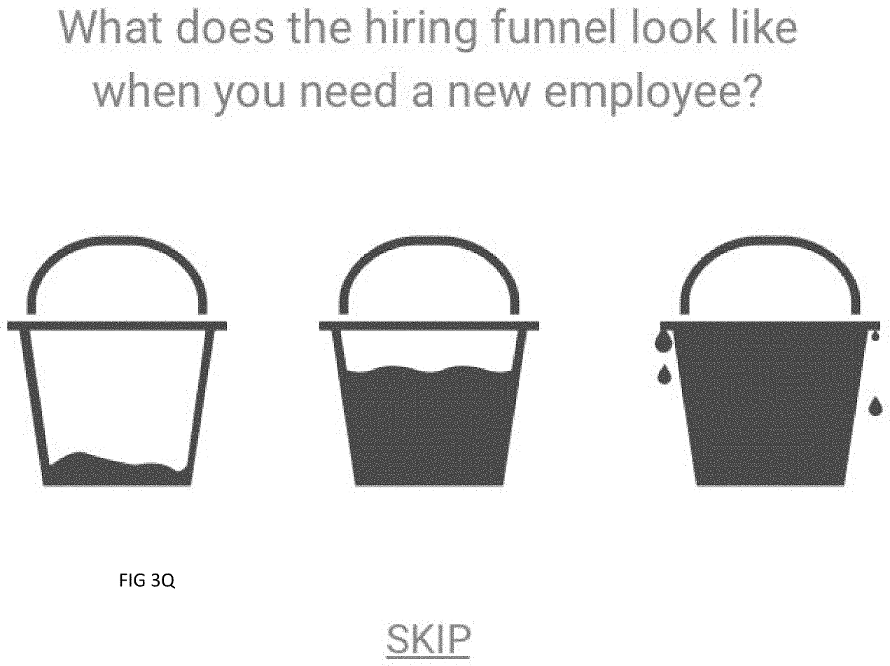

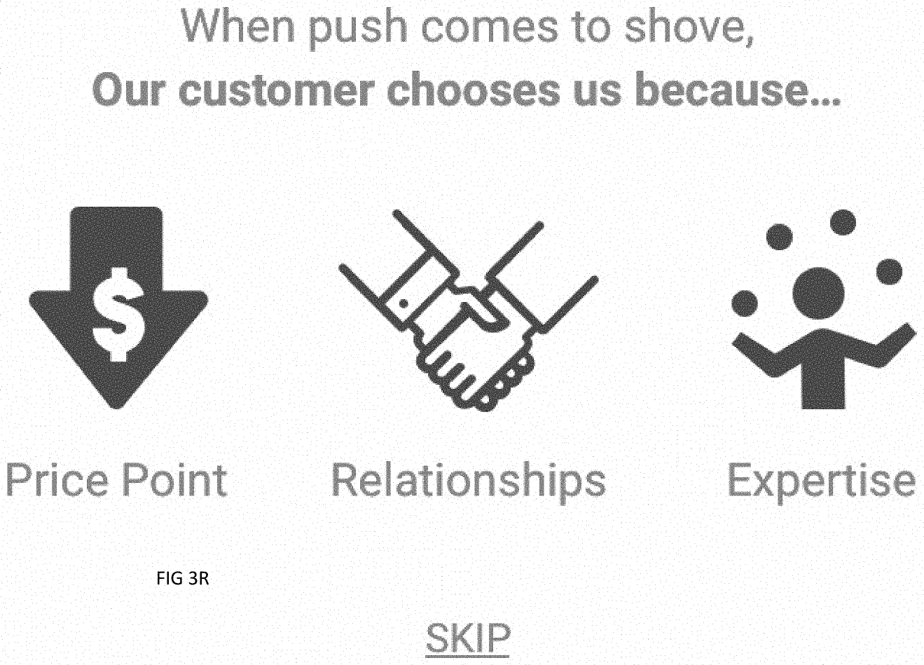

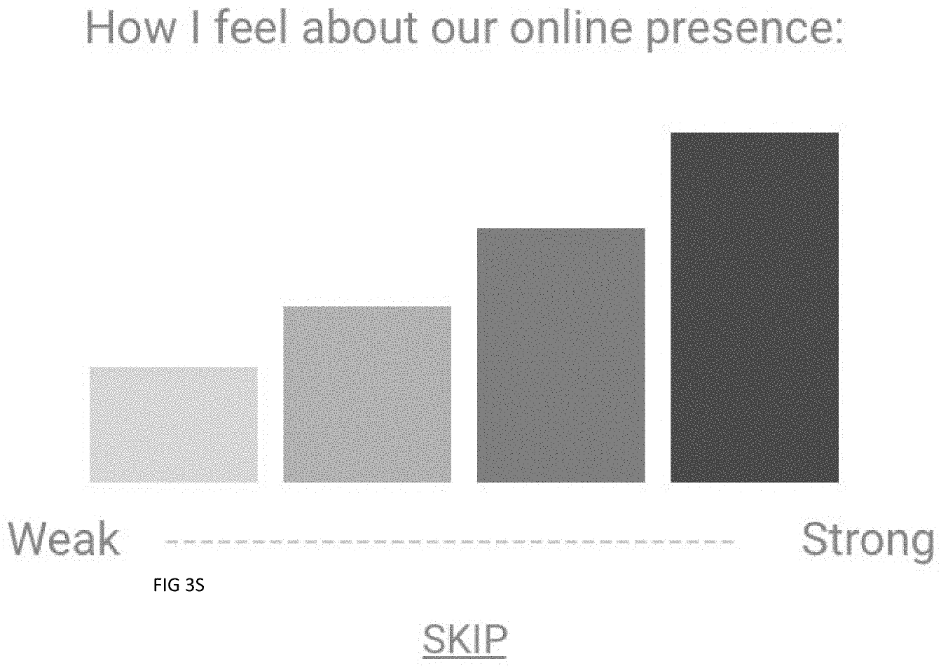

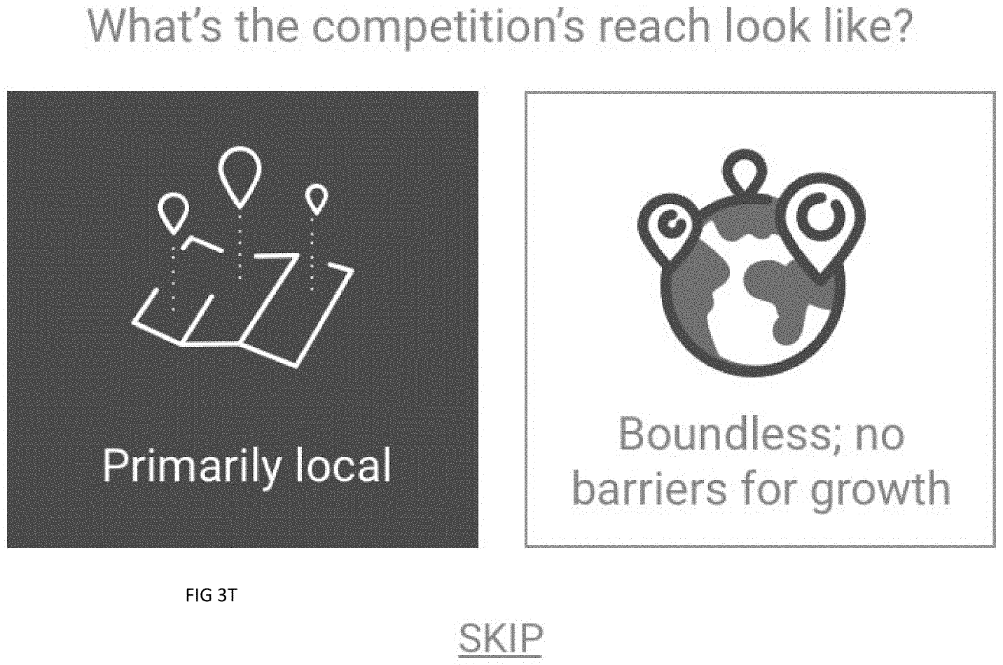

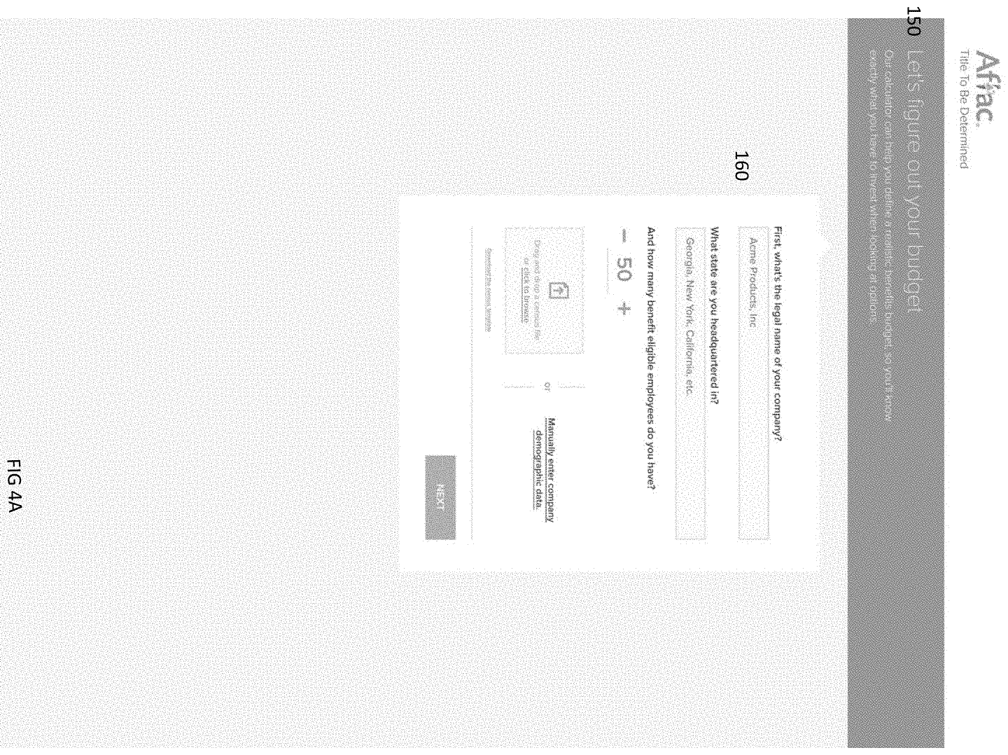

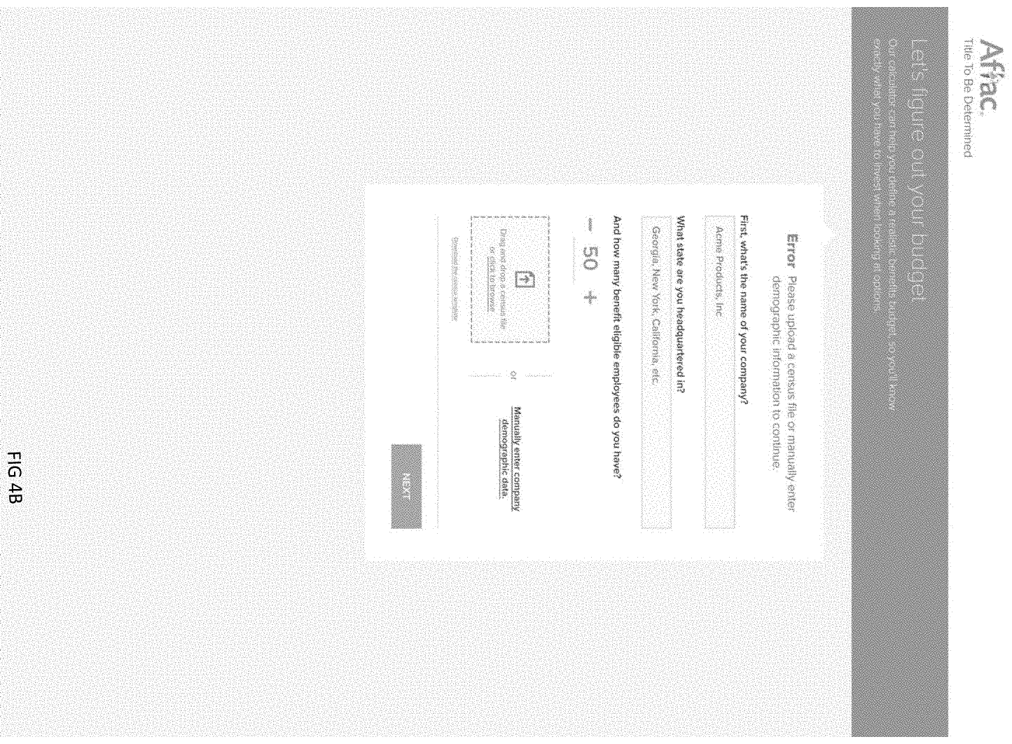

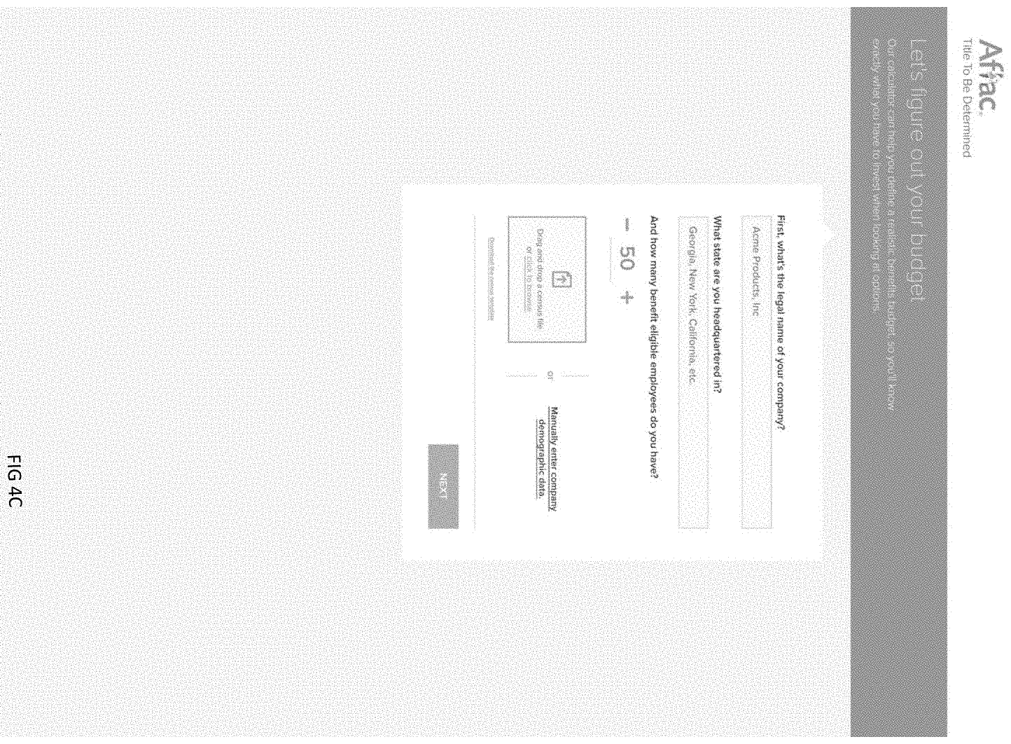

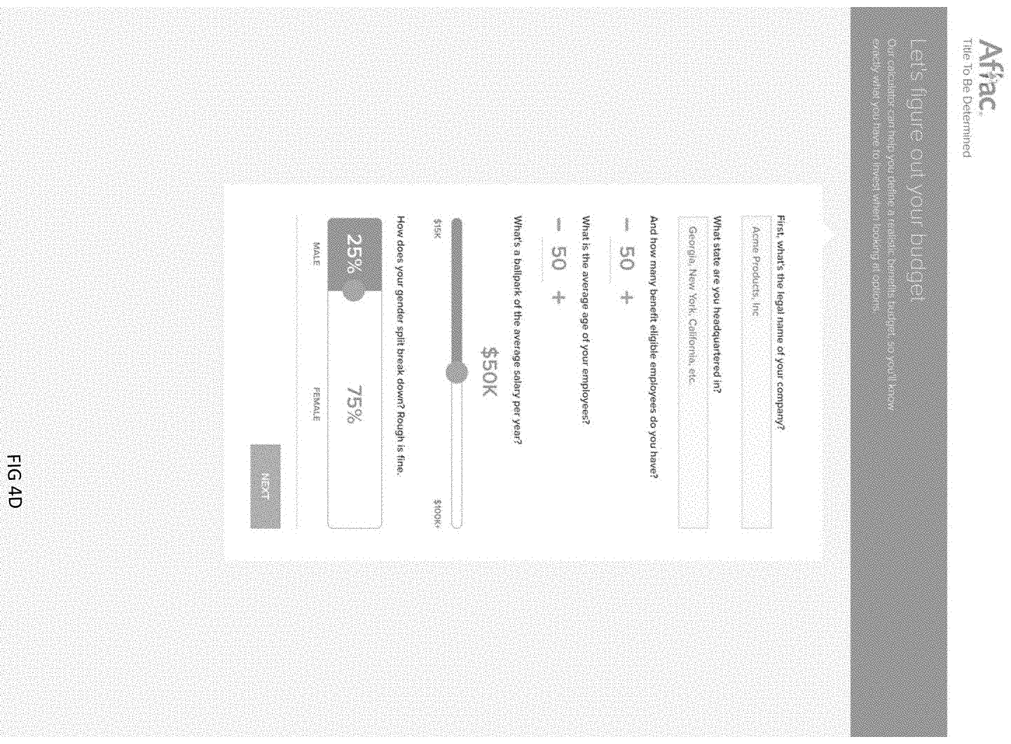

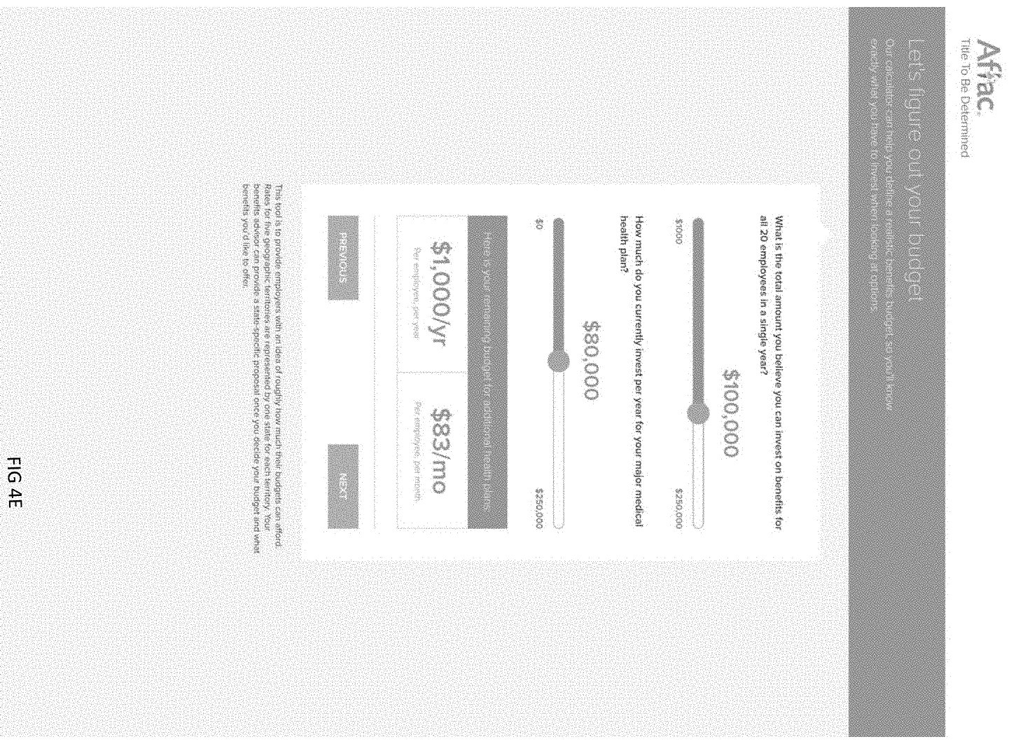

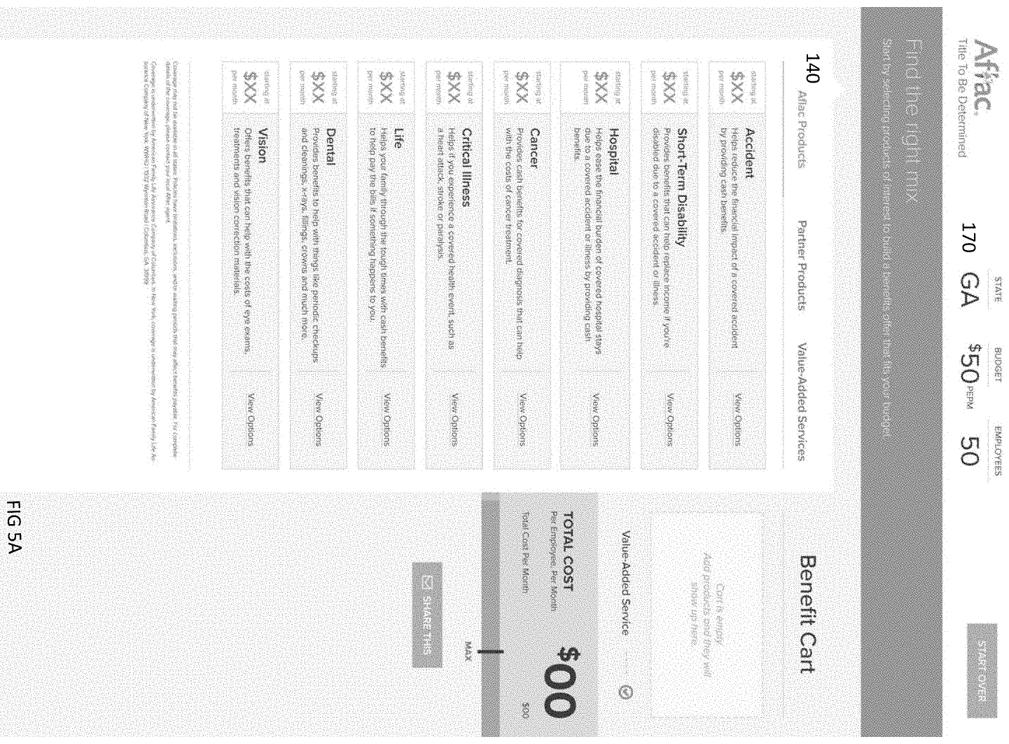

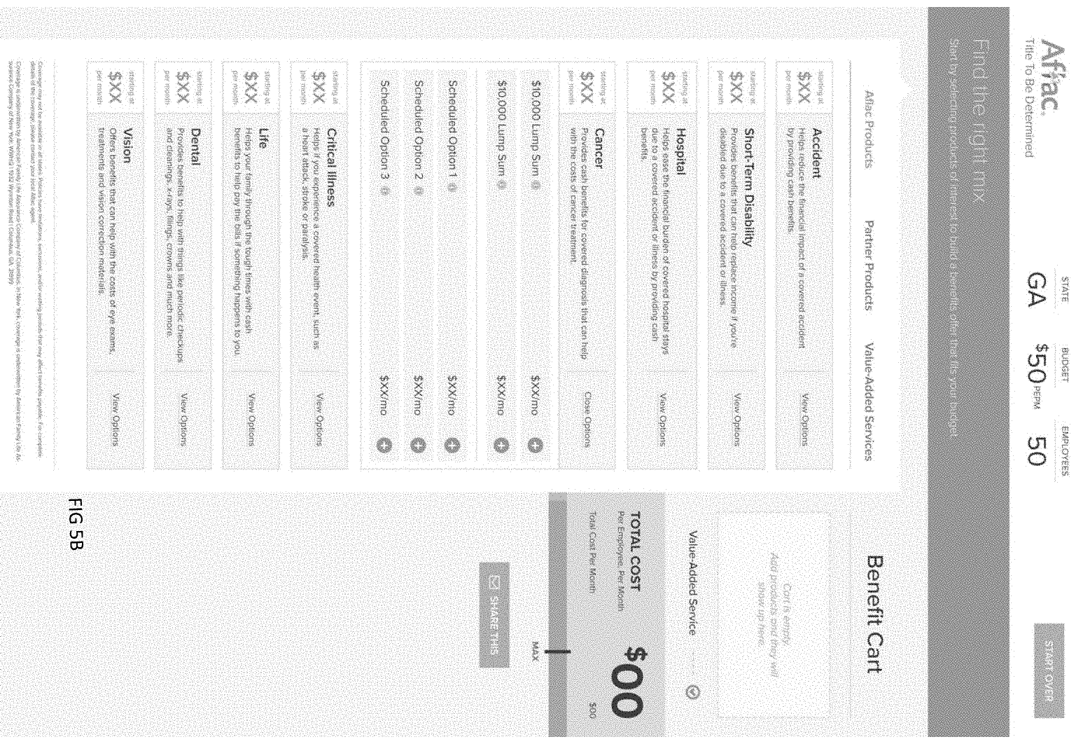

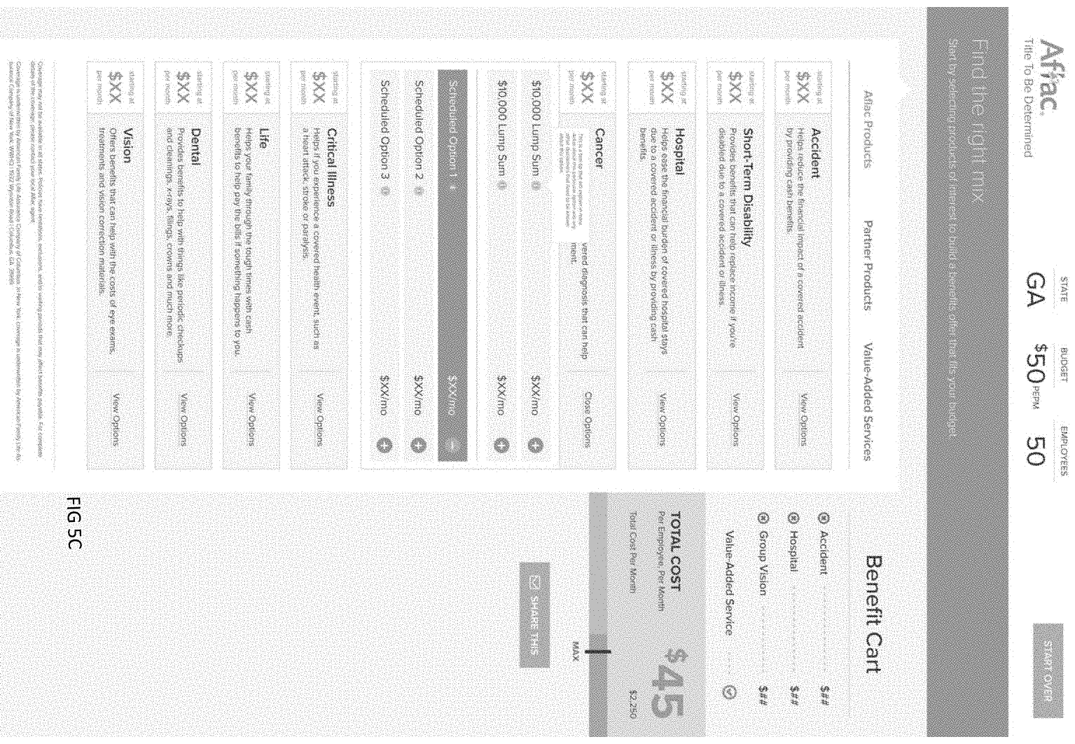

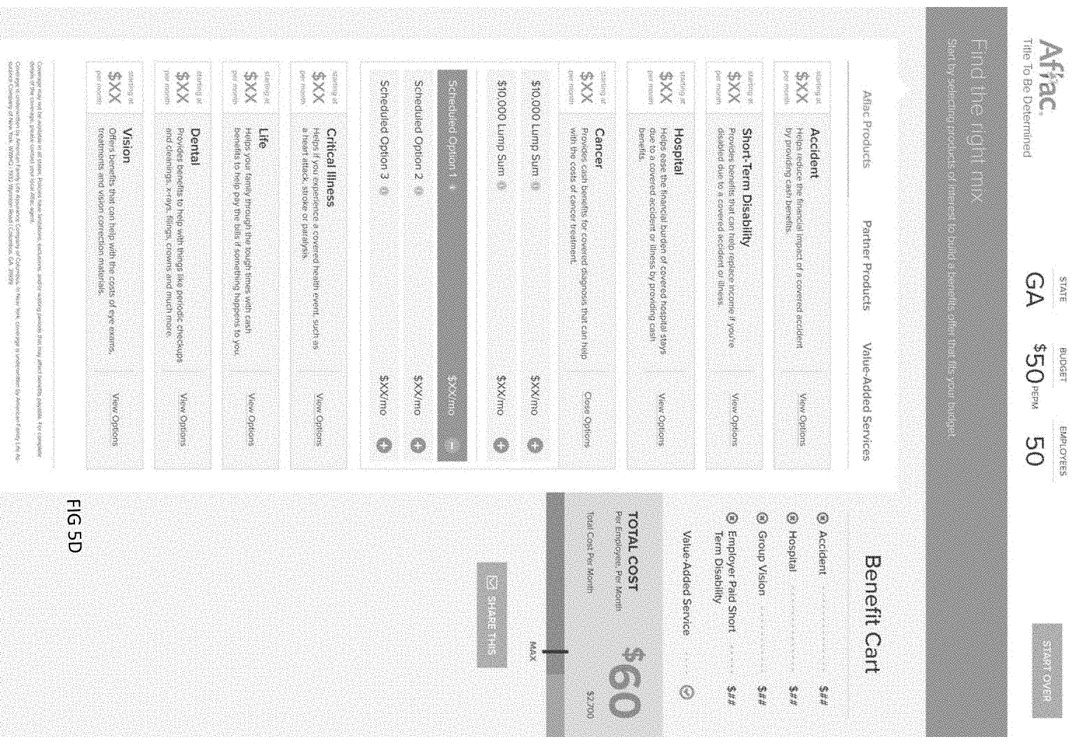

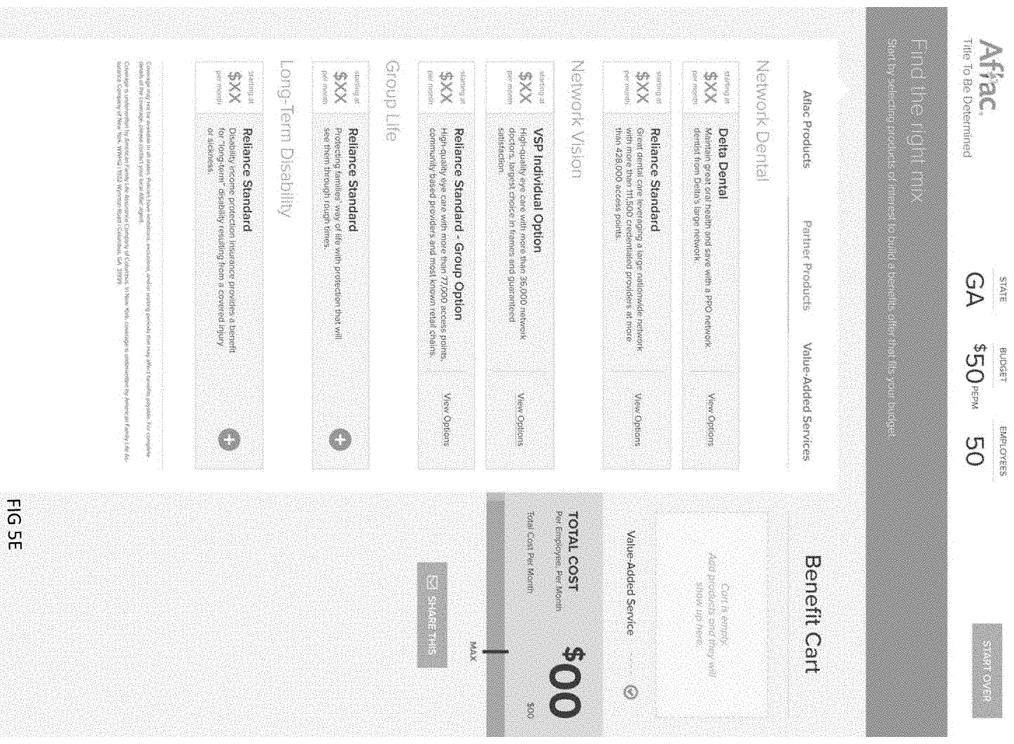

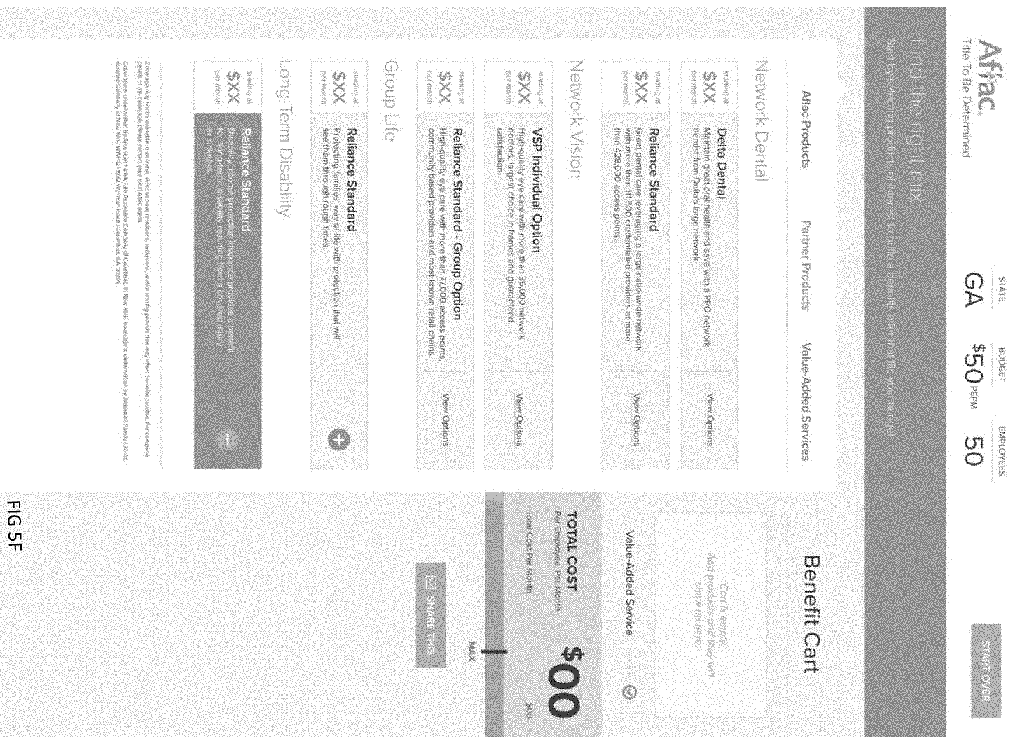

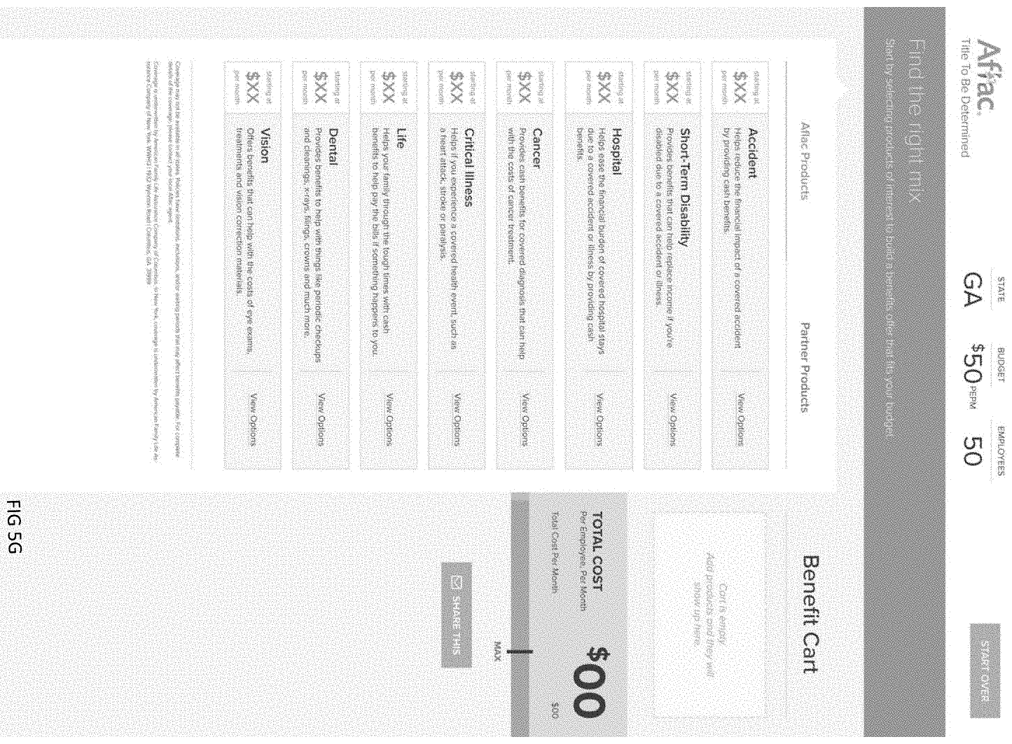

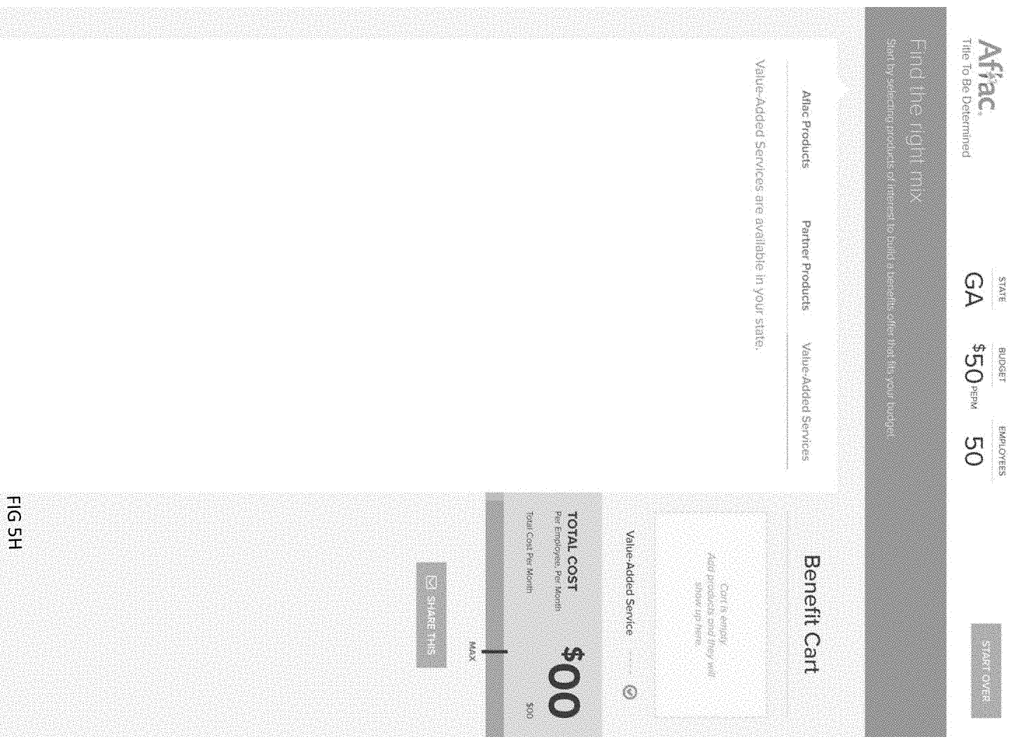

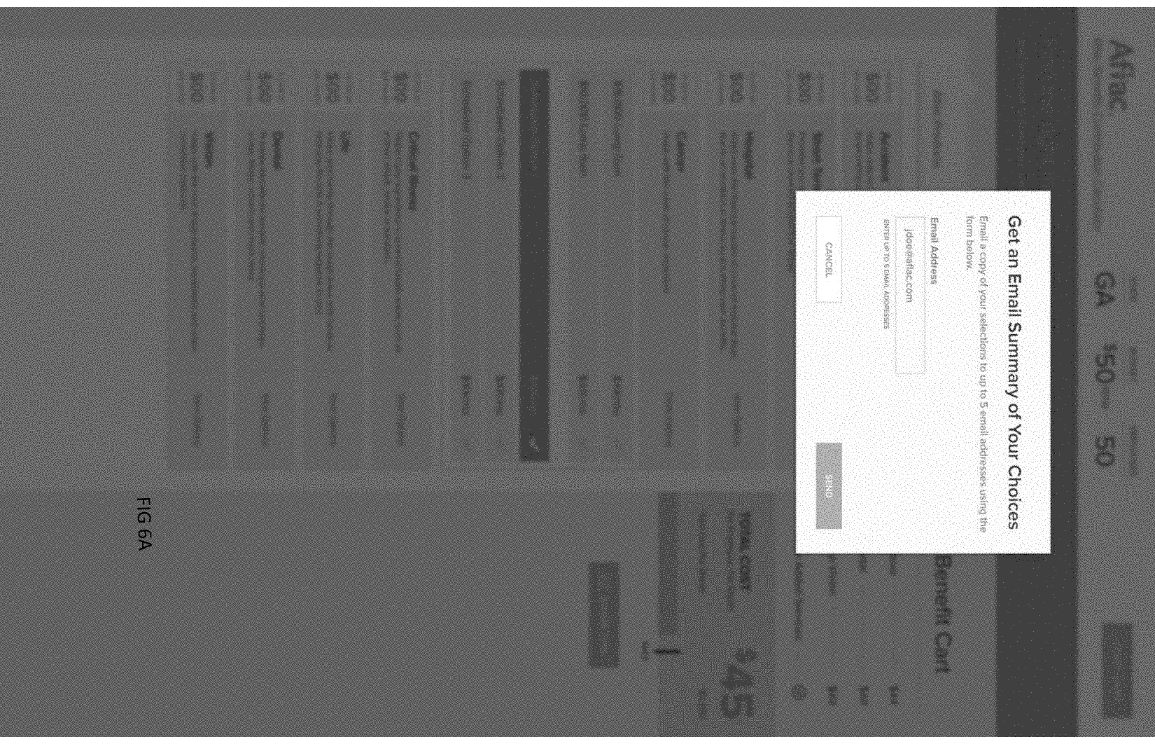

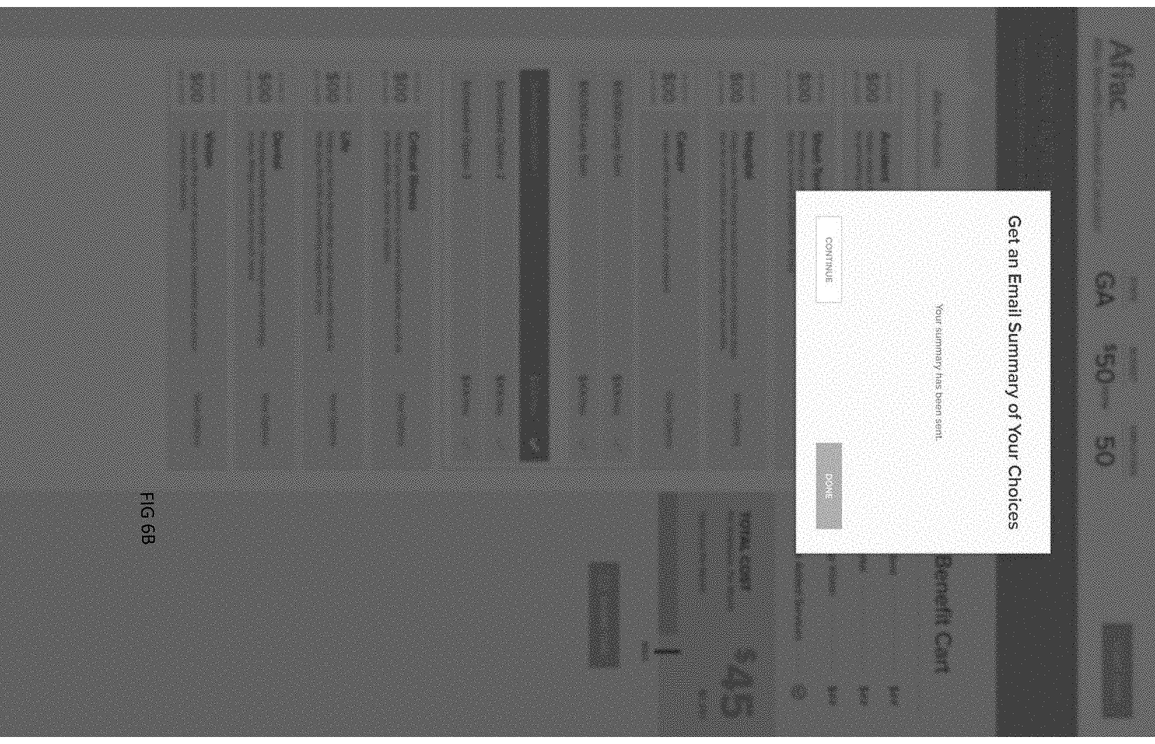

At certain points during the conversation, or at the selection of the sales representative, the program may present various information 120 in one or more formats such as graphs, charts, meters, etc. along with the opportunity for the sales representative to write notes 130, share the results with the customer and/or another sales representative or some other party. The program may provide a review of the conversation FIGS. 2A-D along with an explanation as to what an answer implies about the customer.

Once enough information is determined about the company, the program may present a list of products/services 140 that may be suitable to address one or more of the problems which are discovered as a result of the conversation. The program may begin the conversation with a default list and refine the list along the way, or the program may provide a list of goods/services at various points during the conversation.

In one or more embodiments, the system may include a defined contribution planning feature 150. The defined contribution planner 150 may use the information previously provided about the company or it may request that company information 160 (e.g. defined contribution plan related information such as but not limited to: company name, address, number of eligible employees, etc.) be entered. The information may be entered manually, or it may be uploaded from a file. The feature may request additional defined contribution plan related information such as the average age, average salary and gender breakdown of the employees and it may request the amount of money budgeted or potentially budgeted for employee benefits for the year along with the current amount spent for major medical insurance. Those skilled in the art will recognize that the information collected may include all, some or none of this information and/or additional information. Once the information is collected, the system may provide a visual 170 and or audible indication of the breakdown of the amount of money the company has available to spend on each employee. The breakdown may be by year, month or both.

Once the system has the information it may provide a list of products 140 which fit within the company budget. It may provide options for each product and/or it may provide an amount to spend on that product. A running tally may be provided in the form of a chart, graph, text, and/or a meter which indicates the cost of the selected products compared to the proposed budget. This enables the consumer/company to fine tune the benefits package that they wish to purchase.

Having thus described preferred embodiments of the technology, advantages can be appreciated. Variations from the described embodiments exist without departing from the scope of the invention. Thus, it is seen that systems and methods are provided for assisting sales representatives to generate a list of questions for potential customers and provide them with products and/or services that address one or more needs of the company, which are determined as a result of the conversation. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the technology as defined by the claims. Other aspects, advantages, and modifications are considered to be within the scope of the following claims. The claims presented are representative of the technology disclosed herein. Other, unclaimed technology is also contemplated. The patentee reserves the right to pursue such technology in later claims.

Insofar as embodiments of the technology described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the technology. For example, the carrier medium may be solid-state memory, flash memory with an integrated Universal Serial Bus (USB) interface, optical or magneto-optical memory such as a readable and/or writable disk for example a compact disk (CD) or a digital versatile disk (DVD), or magnetic memory such as disk or tape, or mobile phone and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the technology, what is claimed as new and secured by Letters Patent is:

1. A computer-implemented method for generating a list of questions conducive for a sales conversation between a sales representative and a customer, the sales conversation being related to a technology of the customer, at least a portion of the method being performed by a computing device, the computing device comprising at least one processor and input and a display, the method comprising:
the computing device displaying a first set of questions on the display;
the computing device receiving a response to at least one question;
the computing device determining a follow-up set of questions to the at least one question and displaying the follow-up set of questions on the display; and,
the computing device determining at least one pain point for the customer based at least in part on the received response.

2. The method according to claim 1 further including the computing device determining at least one product recommendation based at least in part on the received response and displaying the at least one product recommendation on the display.

3. The method according to claim 1 further including the computing device associating a weight with the at least one question.

4. The method according to claim 1 further including the computing device associating a respective weight with each question in the first set of questions.

5. The method according to claim 1 further including the computing device receiving information about the customer wherein the information is selected from the group of information consisting of customer technology, defined contribution related information and customer information.

6. The method according to claim 5 wherein the received information is defined contribution related information and the computing device determines a breakdown of an amount of money the company can budget for its employees.

7. The method according to claim 1 further including the computing device displaying a status of a parameter related to the conversation wherein the status is based at least in part on the received response.

8. The method according to claim 1 wherein the sales representative and the customer are both connected to the computing device.

9. The method according to claim 1 wherein the received response is displayed on the display as an image.

10. A non-transitory computer-readable medium comprising one or more computer-executable instructions that, when executed by at least one processor of a computing device, cause the computing device to:
display a first set of questions on a display;
receive a response to at least one of the questions;
determine a follow-up set of questions to the at least one question;
display the follow-up set of questions on the display the computing device determining at least one product recommendation based at least in part on the received response and displaying the at least one product recommendation on the display.

11. The non-transitory computer-readable medium according to claim 10 further including the instructions causing the computer device to determine at least one pain point for a customer based at least in part on the received response.

12. The non-transitory computer-readable medium according to claim 10 further including the instructions causing the computer device to display a list of available technology topics to select from.

13. The non-transitory computer-readable medium according to claim 10 further including the instructions causing the computer device to request information about a customer wherein the information is selected from the group of information consisting of customer technology, defined contribution related information and customer information.

14. The non-transitory computer-readable medium according to claim 13 wherein the received information is defined contribution related information and the computing device determines a breakdown of an amount of money the company can budget for its employees.

15. The non-transitory computer-readable medium according to claim 10 further including the instructions causing the computer device to display a status of a parameter related to the questions wherein the status is based at least in part on the received response.

16. The non-transitory computer-readable medium according to claim 10 further including the instructions causing the computer device to display the received response as an image.

17. The non-transitory computer-readable medium according to claim 10 further including the instructions causing the computer device to associating a weight with the at least one question.

18. A system for generating a list of questions conducive for a sales conversation between a sales representative and a customer, the sales conversation being related to a technology of the customer, the system comprising:
a storage device storing a plurality of questions for the sales representative to ask the customer and a set of product identifications;
an input receiving a response to at least one of the questions;
a logic configured to determine another of the questions for the sales representative to ask the customer based at least in part on the received response; and,
to determine at least one product identification to recommend based at least in part on the received response.

19. The system according to claim 18 further including the storage device including at least one question related to a defined contribution plan and the logic determining a breakdown of an amount of money the company can budget for its employees based at least in part on a response received, by the input, to the defined at least one defined contribution plan question.

20. The system according to claim 18 wherein the system includes a network connection wherein the customer connects to the system via the network connection.
